(19) United States
(12) Patent Application Publication
(10) Pub. No.: US 2026/0133672 A1
(43) Pub. Date: May 14, 2026

(54) Graphical User Interface

(71) Applicant: Xero Limited, Te Aro, Wellington (NZ)

(72) Inventor: Alana Braddon-Parsons, Te Aro, Wellington (NZ)

(21) Appl. No.: 19/120,075

(22) PCT Filed: Oct. 24, 2023
(86) PCT No.: PCT/NZ2023/050110

§ 371 Date: Apr. 10, 2025

(30) Foreign Application Priority Data
Oct. 25, 2022 (AU) 2022903160

(51) Int. Cl. G06F 3/0482; G06F 40/177

(52) U.S. Cl. CPC G06F 3/0482; G06F 40/177

(57) ABSTRACT

A GUI is configured to: display a table of cells in which one cell at a time has focus cell status, the table of cells comprising a plurality of autocompleter cells; respond to an input from a user input mechanism at an autocompleter cell by opening a dropdown menu comprising a first dropdown menu item and a plurality of second dropdown menu items, wherein the first dropdown menu item is fixed in position at a top position of the dropdown menu throughout display of the dropdown menu. The second dropdown menu items are a dynamic subset of members from among a set of candidate cell content text strings. The GUI is operable to dynamically configure membership of the dynamic subset during display of the dropdown menu according to inputs received via user input mechanisms and comprising: a filtering input string.

### INTRODUCTION

The present invention lies in the field of graphical user interface GUI design, and in particular relates to GUI processing of user inputs.

### BACKGROUND

Tabular data is required in many scenarios. However entry and modification of tabular data is time-consuming and presents many challenges to designers of graphical user interfaces.

Certain tables restrict inputs to a cell according to a defined list of options. It is desirable to provide a user with a GUI that enables fast and convenient access to the list of options, identification of a desired value from the list, and subsequent commitment of the value to the table and navigation around the table.

GUIs often suit a specific user input mechanism but are cumbersome for users of other user input mechanisms. It is desirable to provide a GUI enabling entry and manipulation of tabular data in which cell contents belong to a defined list of options which is fast and convenient to use for users regardless of input mechanism.

### SUMMARY

Embodiments include an apparatus comprising processor hardware and memory hardware, the memory hardware storing processing instructions which, when executed by the processor hardware, cause the processor hardware in cooperation with the memory hardware to provide a graphical user interface, GUI, the GUI being configured to: display a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells; respond to an input from a user input mechanism fulfilling a dropdown trigger criteria at an autocompleter cell by opening a dropdown menu corresponding to the said autocompleter cell; the dropdown menu comprising a first dropdown menu item and a plurality of second dropdown menu items, wherein the first dropdown menu item is fixed in position at a top position of the dropdown menu throughout display of the dropdown menu; wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising: a filtering input text string and optionally also scrolling user inputs.

The GUI may be a web-based GUI. The GUI may be an interface forming part of a web-based application.

An autocompleter cell is a cell within a table of cells, the cell content being constrained to take one of a predefined set of values. The predefined set of values are presented to the user as selectable items within a dropdown menu which opens once user interaction with the cell satisfies a trigger criteria (which may be a mouse click, a press of a particular key, or a cursor hover time), the selectable items within the dropdown menu are autofiltered according to a text string input to the cell by the user (the filtering input text string).

Optionally, each candidate cell content text string corresponds to an object within the application, the object being a data item having a plurality of user selectable parameters. For example, the object may be a data representation of a real-world entity. The real world entity may be a specific instance such as a legal entity, or may be a generic such as a product line. The text string may be a title, descriptor, codification, or some other text-based representation of the object. The set of candidate cell content text strings may be composed of multiple unique text strings, or it may be configured such that text strings can match but correspond to different objects (i.e. the text string “golf balls” may be in the set twice, with each referring to different pack sizes.

Optionally, the filtering input string is input received via a keyboard input mechanism or by a paste action and defining a text string, the membership of the dynamic subset being dynamically configurable by filtering out members from the population of candidate cell content objects not including the defined text string.

Optionally, if the user input mechanism used to change the cell having the focus cell status to an autocompleter cell is a cursor moving device and associated selector, the input fulfils the dropdown trigger criteria and the dropdown menu is automatically opened; if the user input mechanism used to change the cell having the focus cell status to an autocompleter cell is a tab key of a keyboard, the input does not fulfil the dropdown trigger criteria and the dropdown menu is not opened unless a further input is received fulfilling the dropdown trigger criteria before the cell having the focus cell status is changed.

Optionally, selection of the first dropdown menu item via a user input initiates processing to create a new member of the population of candidate cell content objects, and to set the content of the focus cell according to the new member.

Optionally, in the dropdown menu, one dropdown menu item at a time has focus item status, the one dropdown menu item having focus item status being dynamic according to focus item navigation inputs received via a user input mechanism, wherein the GUI is configured upon opening the dropdown menu to set the one dropdown menu item having focus item status as one from among the second dropdown menu items.

Optionally, the GUI is configured to respond to a selection input from a user input mechanism while the dropdown menu is open by setting the content of the autocompleter cell having focus cell status according to the dropdown menu item having focus item status.

Optionally, if a focus cell navigation input to change the cell having the focus cell status away from an autocompleter cell is received by the GUI during display of the dropdown menu at the autocompleter cell, and the user input mechanism used to provide the focus cell navigation input is a keyboard, the GUI responds by setting the content of the said autocompleter cell according to the one dropdown menu item currently having focus item status and navigating the focus cell status according to the focus cell navigation input; if a focus cell navigation input to change the cell having the focus cell status away from an autocompleter cell is received by the GUI during display of the dropdown menu at the autocompleter cell, and the user input mechanism used to provide the focus cell navigation input is a cursor moving device and associated selector, the GUI responds by determining a number of members of the population of candidate cell content text strings match or contain a filtering input text string present in the cell having focus cell status, setting the content of the cell having focus cell status to the filtering input text string, and if the number is one, determining the cell content to be validated, and if the number is zero or greater than or equal to two, determining the cell content to be invalidated and displaying a warning to a user; and navigating the focus cell status according to the focus cell navigation input.

Optionally, while the cell having focus cell status is an autocompleter cell, a directional down key press from a keyboard fulfils the dropdown trigger criteria and the GUI responds by opening the dropdown menu with a top-most menu item among the second menu items as the dropdown menu item having focus item status; while the cell having focus cell status is an autocompleter cell, an alphanumeric key press from a keyboard fulfils the dropdown trigger criteria and the GUI responds by opening the dropdown menu with the dynamic subset of members forming the second dropdown menu items is filtered according to the alphanumeric key press applied as a filtering user input, and a top-most menu item among the filtered dynamic subset is set as the dropdown menu item having focus item status.

Optionally, the population of candidate cell content objects is defined on a per column basis according to the column to which each autocompleter cell belongs.

Optionally, the GUI renders the dropdown menu dynamically according to the instantaneous dynamic subset, and wherein a dropdown menu item having focus item status is rendered with a background colour different from a single background colour used to render a background of all other dropdown menu items.

Optionally, an autocompleter cell presently having focus cell status has cell content corresponding to a member of the dynamic subset at a time of obtaining focus cell status, and the GUI renders the dropdown menu dynamically according to the instantaneous dynamic subset, and wherein a text string of a dropdown menu item corresponding to the said member of the dynamic subset is rendered with a font colour different from a single font colour used to render text strings of all other dropdown menu items.

Optionally, each member of the population of candidate cell content text strings is a title or descriptor of an object defined in an application to which the GUI belongs and having at least one property in addition to the title or descriptor, wherein the second dropdown menu items are represented in the menu by the candidate cell content text string being the title or descriptor of the object, and by a tag or label representing, detailing, or indicating one or more of the at least one property additional to the title or descriptor.

Optionally, each member of the population of candidate cell content text strings is a title or descriptor of an object defined in an application to which the GUI belongs comprises, and the dropdown menu further comprises a third dropdown menu item, the third dropdown menu item is an option to leave the cell blank or empty.

Optionally, the graphical user interface is web-based and is a portion of a web-application.

Optionally, the graphical user interface is a single page application.

Embodiments may include a computer-implemented method, comprising: at a graphical user interface: displaying a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells; responding to an input from a user input mechanism fulfilling a dropdown trigger criteria at an autocompleter cell by opening a dropdown menu corresponding to the said autocompleter cell; the dropdown menu comprising a first dropdown menu item and a plurality of second dropdown menu items, wherein the first dropdown menu item is fixed in position at a top position of the dropdown menu throughout display of the dropdown menu; wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising: a filtering input text string and optionally also comprising scrolling user inputs.

Embodiments may include a computer program comprising processing instructions which, when executed by a computing apparatus having a memory and a processor, cause the memory and the processor to perform a method comprising: at a graphical user interface: displaying a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells; responding to an input from a user input mechanism fulfilling a dropdown trigger criteria at an autocompleter cell by opening a dropdown menu corresponding to the said autocompleter cell; the dropdown menu comprising a first dropdown menu item and a plurality of second dropdown menu items, wherein the first dropdown menu item is fixed in position at a top position of the dropdown menu throughout display of the dropdown menu; wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising: a filtering input text string, and optionally also scrolling user inputs.

The computer program may be stored by a computer-readable medium. The computer-readable medium may be a non-transient computer-readable medium.

Embodiments include a GUI configured to: display a table of cells in which one cell at a time has focus cell status, the table of cells comprising a plurality of autocompleter cells; the GUI configured to respond to an input from a user input mechanism at an autocompleter cell by opening a dropdown menu comprising a first dropdown menu item and a plurality of second dropdown menu items, wherein the first dropdown menu item is fixed in position at a top position of the dropdown menu throughout display of the dropdown menu; wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising: a filtering input string.

### LIST OF FIGURES

Embodiments are illustrated, by way of example, in the accompanying drawings, in which:

FIG. 1 illustrates a process;

FIG. 2A illustrates a dropdown menu;

FIG. 2B illustrates a dropdown menu;

FIG. 3 illustrates a processing flow;

FIGS. 4A to 25C illustrate screenshots from a GUI;

FIG. 26 illustrates a hardware arrangement.

### DETAILED DESCRIPTION

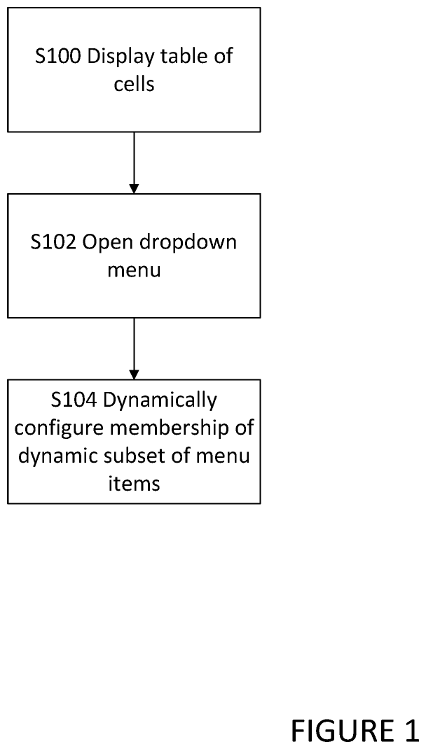

FIG. 1 illustrates a process. The process comprises step S100, displaying a table of cells, step S102, opening a dropdown menu, and step S104, dynamically configuring membership of a dynamic subset of menu items. The steps are presented as a sequence, but in practice S100 persists while S102 and S104 are being performed, and S102 persists while S104 is being performed.

The process of FIG. 1 is a computer-implemented method and may be performed by a computing apparatus, which may be a single computer or a plurality of interconnected computers communicating over a network. The network may be the internet. Such a computing apparatus may include processor hardware and memory hardware, the memory hardware storing processing instructions which, when executed by the processor hardware, cause the processor hardware in cooperation with the memory hardware to provide a graphical user interface, GUI. The GUI is an application or program which provides a graphical user interface and includes underlying processing logic for handling user interactions (i.e. user inputs) with the GUI. The process illustrated in FIG. 1 comprises steps which may be considered to be performed by the GUI or by the computing apparatus implementing the GUI.

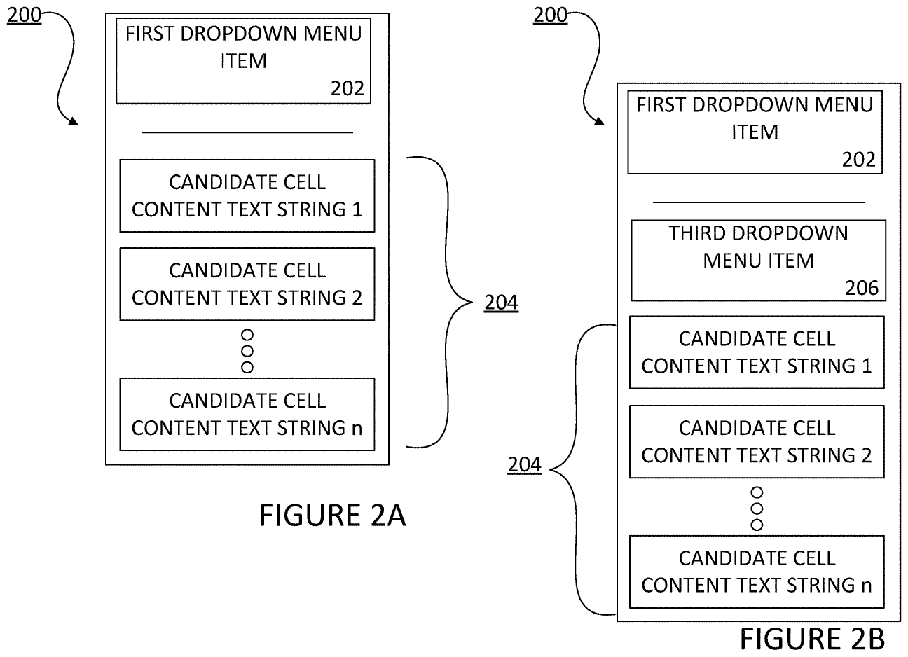

FIG. 2A illustrates an example of a dropdown menu 200. The dropdown menu 200 contains a first dropdown menu item 202 and a plurality of second dropdown menu items 204. The first dropdown menu item 202 is fixed in position at a top position of the dropdown menu throughout display of the dropdown menu (i.e. while the dropdown menu is open). The second dropdown menu items 204 that are displayed are a dynamic subset 204 of members from among a population of candidate cell content text strings. The GUI is operable to dynamically configure S104 membership of the dynamic subset during display of the dropdown menu according to inputs received via user input mechanisms and comprising scrolling user inputs and filtering user inputs. The dropdown menu 200 of FIG. 2A is discussed below in the context of the process of FIG. 1. Scrolling user inputs are user inputs which have the effect of shifting a displayed subset of menu items from within the broader population, such as clicking (or otherwise selecting with a cursor moving device) and dragging a scroll bar illustrated at the side of the dropdown menu, rotating a scrolling wheel on a mouse or equivalent input device, or continuing to press an up or down directional key to navigate focus item status when the menu item having focus item status is already the top or bottom displayed menu item. Scrolling user inputs are user inputs which moves the displayed part of the population of menu items up or down. Scrolling use inputs have a directional component (up or down) and a magnitude component, which may be defined by a number of directional key presses, a length of a click and drag action, or a number of revolutions (or angular distance travelled) of a scrolling wheel. Scrolling is the act of moving a visual portion of a window, in this context the window being the region of the dropdown menu occupied by the dynamic subset of second menu items, in order to change the information displayed within that window. Scrolling user inputs are the user inputs that give rise to scrolling in the window. Scrolling user inputs may be required in some circumstances and not in others. GUI is configured with a vertical height per dropdown menu item and a finite amount of vertical space for second dropdown menu items, so when the number of candidate cell content text strings after filtering is such that the vertical height per dropdown menu item x number of candidates after filtering exceeds the finite amount of vertical space for second dropdown menu items, the GUI is configured to respond to scrolling inputs by shifting the boundaries of the displayed/not-displayed items within the items remaining after filtering.

FIG. 2B illustrates a variant of the dropdown menu 200. In the dropdown menu 200 of FIG. 2B, the dropdown menu 200 also includes a third dropdown menu item 206. The third dropdown menu item 206 belongs to the collective of second dropdown menu items. In particular, the third dropdown menu item 206 represents a candidate cell content value and responds to filtering inputs. However, whereas the members of the dynamic subset 204 are text strings that are selectable as cell contents, the third dropdown menu item represents a blank cell, or a null value. For example, it may be used by a user wishing to replace a current cell content with a blank cell. The third dropdown menu item is selectable in the dropdown menu item, however the GUI responds to filtering inputs from the keyboard (i.e. an input text string that filters the population of candidate cell content text strings) by filtering out the third dropdown menu item as soon as an alphanumeric character is received as a filtering input. Since, it can be assumed that in that case the blank cell is not desired by a user. In this regard, the third dropdown menu item 206 is handled by the GUI in a different manner from the candidate cell content text strings 204, because the candidate cell content text strings 204 are filtered according to the text string displayed in the menu, whereas the third dropdown menu item 206 is filtered according to a blank value (whereas in the dropdown menu it may be displayed as “no item”, ‘blank” or equivalent.

Step S100, display table of cells, may comprise displaying a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells.

An autocompleter cell is a cell having particular properties. In particular, the content of an autocompleter cell is constrained to have one of a defined set of candidate cell content text strings, which may be referred to as a candidate set. The candidate set may be predefined. In addition to being predefined, the GUI enables a user to add a new member to the candidate set during execution of the process. So that, whilst the content of the autocompleter cell is constrained to have one of the candidate set of text strings, the set may be expanded to include a new text string if the user wishes for the cell content to be a text string not predefined in the candidate set (i.e. not in the set at a time of opening the dropdown menu S102). The first dropdown menu item 202 may be selectable to initiate processing to add a new member to the candidate set.

Whether or not a navigation input (i.e. via tab keys, directional keys, cursor moving device, eye gaze, etc) to change the cell having focus cell status also causes the dropdown menu to open (such as at S102) is conditional on the input mechanism. A navigation into a cell by a cursor moving device (mouse, eye gaze, trackpad, etc) does satisfy the dropdown open criteria and so the dropdown menu opens. A user with accessibility issues (such as visually-impaired) may be navigating the tabular data with a keyboard and a screen reader that reads aloud to a user content of displayed menus as they appear and change. The GUI is configured so that navigating into a cell by tab key inputs does not satisfy the dropdown open criteria, and so the dropdown menu does not open in response to tabbing focus cell status into a cell, so that a user navigating with the aid of a screen reader has a mechanism to navigate focus cell status without the encumbrance of the screen reader dictating dropdown menu contents each cell. The GUI may be configured to handle user inputs differently on condition of whether or not a screen reader is active.

Autocompleter cells are configured to autocomplete: once a user begins entering a text string to the cell (input via a keyboard input mechanism while the cell has focus cell status), the GUI is automatically filtering the candidate set and dynamically reconfiguring S104 the dropdown menu 200 according to the filtering. The automatic filtering is an example of the dynamic configuration of the dynamic subset 204, which dynamic subset 204 defines the second menu items present in the dropdown menu 200.

The set of candidate cell content text strings is a full population of predefined text strings that may be set as cell contents. The second dropdown menu items 204 are a dynamic subset from among the full population, wherein there are two factors controlling membership of the dynamic subset 204. A first factor is spatial, wherein there is a finite space in the GUI for the dropdown menu 200, and the first dropdown menu item 202 is fixed at a top position, so the remaining space in the dropdown menu 200 is divided among the dynamic subset 204. So, there may be an upper threshold on the number of members of the dynamic subset 204 defined by spatial requirements. The dropdown menu 200 may include a scrolling controller to enable a user to scroll through a number of members within the dropdown menu space allocated for the dynamic subset 204. A second factor is filtering, wherein, based on a text string input to the autocompleter cell (i.e. input by the user via a keyboard input mechanism while the autocompleter cell has focus cell status) the dynamic subset is filtered to include only members from the candidate set that include the input text string, so that effectively the dynamic subset 204 actually displayed in the dropdown menu 200 is a scrollable subset of a filtered candidate set. Or, if space allows, the dynamic subset 204 is the filtered candidate set.

Ordering within the dynamic subset 204 may be, for example, alphabetical, or may be according to some other property of the respective candidate cell content text strings such as popularity (i.e. usage frequency).

Optionally, once the automatic filtering reaches a point whereby only a single member of the candidate set remains in the dropdown menu 200, the cell autocompletes so that the content of the cell is the text string of the said remaining single member. Depending on implementation details, the committing of the content to the cell may require a positive affirmation via an input mechanism such as keyboard, mouse, trackpad, eye gaze, etc.

The automatic filtering reaches a point whereby only a single member of the candidate set remains in the dropdown menu when a text string input by a user while the dropdown menu is open is present in only a single member of the candidate set. The dropdown menu remains open with the single member of the candidate set along with the first dropdown menu item (the fixed option) as the only two visible (i.e. selectable) menu options. Should a user continue to input characters via the keyboard input mechanism and in doing so compose a text string that is not present in any member of the candidate set, the autocompletion of the cell is cancelled so that the cell content is the text string of characters that the user has entered and the dropdown menu with only the first dropdown menu item 202 is visible and has focus item status. Depending on the configuration of the application, it may be that the text string entered by the user does not correspond to any member of the candidate set, therefore effectively defining a new object, which cannot be committed to the cell without completion of a form or some other interaction to positively assert that the new object should be created. Such an interaction, be it completion of the form or other positive assertion, has two effects. A first effect is to commit the text string to the cell (so that upon focus cell navigation away from the cell the string remains in the cell), a second effect is the creation of a new object and corresponding new member of the candidate set. So that, should the same text string be entered into a different cell, it would be present in the dropdown menu as a selectable text string to commit to the cell.

The keyboard input mechanism may be a physical device or may be a portion of a touchscreen display, the portion being a part of a screen displaying the GUI.

An example of the first dropdown menu item 202 is a create new item option. Wherein selection of the create new item option initiates processing to add a new member to the population of candidate cell content text strings. Such an option would be desirable to a user if a text string they wish to set as content of the autocompleter cell does not already exist. The first dropdown menu item 202 is a fixed presence in the dropdown menu 200. However, when the dropdown menu 200 opens and a menu item is initially granted focus item status, the focus item status is not granted to the first dropdown menu item, but to the top menu item among the dynamic subset 204. This continues during entry of a text string by the user and filtering of the population of candidate cell content text strings, so that, by default, focus menu item status is granted to a first among the scrollable subset of the, or if space allows the complete, filtered candidate set. Wherein first is defined in accordance with an ordering logic such as, for example, alphabetical or most common in the table.

The GUI may be configured to effectively bypass the first dropdown menu item in determining which menu item is to have focus item status by, in the code implementing the GUI, wrapping the first dropdown menu item so that it is not recognised by the GUI as a candidate to receive focus item status. In a similar manner, the first dropdown menu item is protectable from the filtering of the dropdown menu content. By wrapping the first dropdown menu item, it is not filtered by the filtering mechanism that operates in the background of the GUI to filter the population of candidate cell content text strings according to the filtering input string. Certain GUI platforms may provide other mechanisms for controlling which item within a dropdown menu has focus item status.

Alternatively, the GUI may be configured to give focus item status to the first dropdown menu item when initiating the dropdown menu. In particular, such a configuration is advantageous to users leveraging a screen reader to navigate the GUI, since giving the first dropdown menu item focus item status causes it to be read out by the screen reader. The GUI may be configured to alter its handling of inputs and of the menu item having focus item status on condition of a screen reader being used or not. For example, upon receipt of a user input triggering opening of the dropdown menu 200, the GUI is configured to detect whether or not a screen reader (i.e. output mechanism converting displayed content to voice content output over a speaker or headphone) is active, and if so, upon initially opening (displaying) the dropdown menu 200 to give focus item status to the first dropdown menu item, and if no active screen reader is detected, upon initially opening (displaying) the dropdown menu 200 to give focus item status to the top-most of the second dropdown menu items (i.e. to pass over or skip the first dropdown menu item and also the third dropdown menu item where present).

The processing to add a new member may simply be to close the dropdown menu and to enable the user to add a freeform text string to the autocompleter cell, which freeform text string is then set as content for the cell and added to the population of candidate cell content text strings. Alternatively, the processing to add a new member may open a form or modal requiring the freeform text string and optionally also selection or other input of one or more other properties of the new member, depending on the object represented by the text string and how that object is defined in the underlying application.

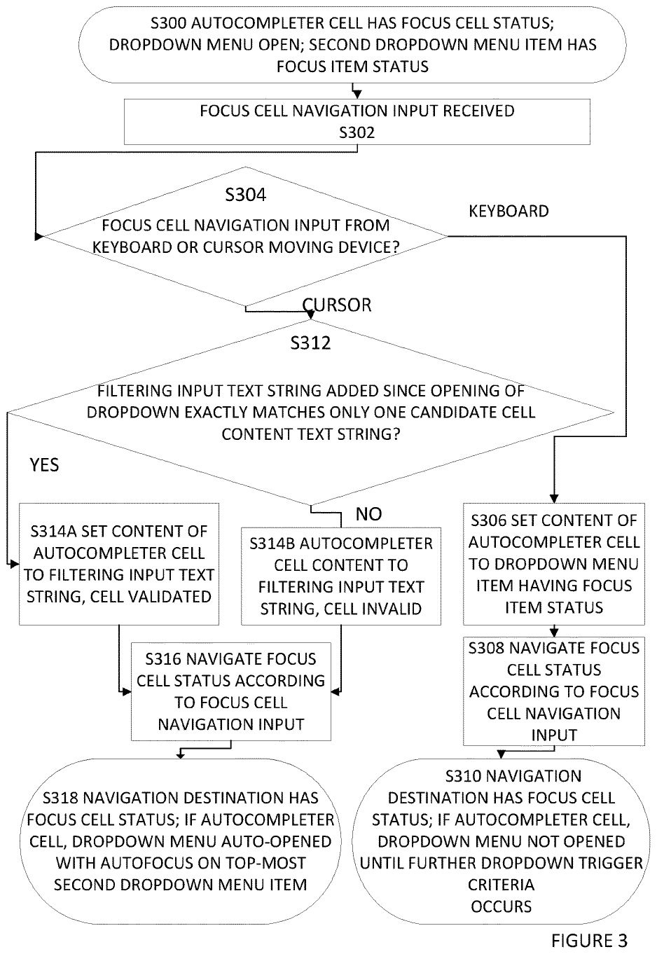

FIG. 3 illustrates a flow of processing. The flow of processing in FIG. 3 highlights two instances of processing that are differentiated per user input mechanism. Firstly, at S304 how the GUI configures the content of an autocompleter cell in response to a focus cell navigation input away from the autocompleter cell to a destination cell (regardless of whether destination cell is an autocompleter cell or otherwise) is dependent upon input mechanism. Secondly, at S310 & S318, if the navigation destination cell is an autocompleter cell, how the GUI controls behaviour of the navigation destination cell is dependent upon input mechanism.

The process starts at S300, the cell having focus cell status in an autocompleter cell for which the dropdown menu is open, and wherein a second dropdown menu item (i.e. a candidate cell content text string) has focus item status.

At S302 a focus cell navigation input is received and at S304 the GUI determines to which category the user input mechanism belongs. The input mechanism categorisations may be keyboard and cursor moving device. Alternatively, the input mechanism categorisations may be keyboard and non-keyboard (noting, throughout this disclosure, that keyboard includes a physical keyboard device and a touchscreen keyboard portion of a touchscreen).

A cursor moving device is taken to mean a mouse, trackpad, eye-gaze, and equivalent input mechanisms, which move a cursor to a desired position with the screen, and which include selectors such as buttons or equivalent mechanisms for registering an input at the cursor position.

Focus cell navigation inputs change the cell having focus cell status from a current cell to a destination cell, the destination cell being defined by a combination of the current cell, the input, and the configuration of the GUI to handle the input. From a keyboard, focus cell navigation inputs may be received via the tab keys, comprising a forward tab key or a key ir combination of keys having equivalent effect and a backward tab key or a key or combination of keys having equivalent effect. The GUI may be configured to respond to forward tab key inputs by moving the cell having focus cell status one cell to the right in the same row, and at the right-end of a row to the left-most cell on the row below; and to respond to backward tab key inputs by moving the cell having focus cell status one cell to the left in the same row, and at the left-end of the row to the right-most cell on the row below. A carriage return key input may also be handled as a focus cell navigation input, and may be equivalent to a forward tab key input, or alternatively may move the cell having focus cell status one cell down in the same column.

The GUI may be configured so that directional key inputs from the keyboard are not handled as focus cell navigation inputs by the GUI. For example, directional key inputs from the keyboard may be handled by the GUI as inputs which navigate focus item status in the dropdown menu, and select and otherwise interact with menu items among the dropdown menu.

If the focus cell navigation input at S302 is determined at S304 to be from a keyboard input mechanism, the flow proceeds to S306. At S306, the dropdown menu item having focus item status, which is a second dropdown menu item and therefore a text string from among the population of candidate cell content text strings, is committed as the content of the autocompleter cell having focus cell status. Reduction in user inputs to update cell content is achieved by obviating any requirement to positively commit the dropdown menu item to the cell (i.e. no carriage return or equivalent key input is required to commit the menu item having focus item status to the cell having focus cell status). At S308 the GUI changes the cell having focus cell status to the destination of the focus cell navigation input.

Conversely, if the focus cell navigation input at S302 is determined at S304 to be from a cursor moving device, the flow proceeds to either S314A or S314B. S314A is effectively the same as S306 but occurs in a very specific circumstance, determined at S312, which is in which the filtering at S104 has reduced the number of members in the filtered version of the population of candidate cell content text strings to one only. In that specific case, GUI assumes, by virtue of having eliminated all other options for cell content from the population of candidate cell content text strings, that the user wants the said one candidate cell content text string to be committed to the cell. At S314A the cell content is validated because it denotes a single member of the population of candidate cell content text strings.

S314B, on the other hand, occurs in the vast majority of cases, which is when at the time of the focus cell navigation input, there is either zero or multiple second dropdown menu items present in the dropdown menu. In that case, the focus cell navigation input from the cursor moving device is handled by the GUI as an instruction to move away from the current focus cell, and the content of the autocompleter cell is set according to the filtering text input, noting that may have been blank. In that case, the GUI runs a validation test to see whether the cell content is valid, which it fails because it does not denote a unique member of the population of candidate cell content text strings. So at S316 the GUI changes the cell having focus cell status to the destination of the focus cell navigation input.

A filtering input string is a text string in the cell having focus cell status. It is used by the GUI to filter the population of candidate cell content text strings. The filtering results are displayed in the dropdown menu as second dropdown menu items, below the first dropdown menu item.

From S316, whether arrived at from S314A or S314B, the process continues to S318. From S308, the flow continues to S310. Process steps S318 and S310 demonstrate how focus cell navigation into an autocompleter cell is handled by the GUI. In particular, they demonstrate how the handling is dependent upon the input mechanism. It is noted that S318 represents handling of focus cell navigation into an autocompleter cell by a cursor moving device, and that said handling is not exclusive to the context of FIG. 3 but generally applies to any focus cell navigation into an autocompleter cell by a cursor moving device in the GUI. Likewise, S310 represents handling of focus cell navigation into an autocompleter cell by a keyboard input mechanism, and that said handling is not exclusive to the context of FIG. 3 but generally applies to any focus cell navigation into an autocompleter cell by a keyboard input mechanism in the GUI.

In S318, because the cursor moving device enables any visible cell to be selected as focus cell navigation destination, an assumption is made that the user wishes to interact with the destination cell. If the destination cell is an autocompleter cell, then focus cell navigation into the cell in itself fulfils the dropdown trigger criteria and the dropdown menu automatically opens with the first dropdown menu item and plural second dropdown menu items, and initially the dropdown menu item having focus status is a top-most among the second dropdown menu items. In the context of FIG. 2A that would be the “candidate cell content text string 1”.

In S310, because the tab keys only enable a user to change a cell having autofocus status to neighbouring cells, plural cells may need to be traversed to reach a cell that the user next wishes to interact with. Therefore, the assumption is that simply navigating to a cell with a tab key does not imply user wishes to interact with the cell, and thus navigation into an autocompleter cell with a tab key does not fulfil the dropdown trigger criteria unless a further trigger action occurs. Example of such a trigger action is a carriage return key input, or a directional down key input.

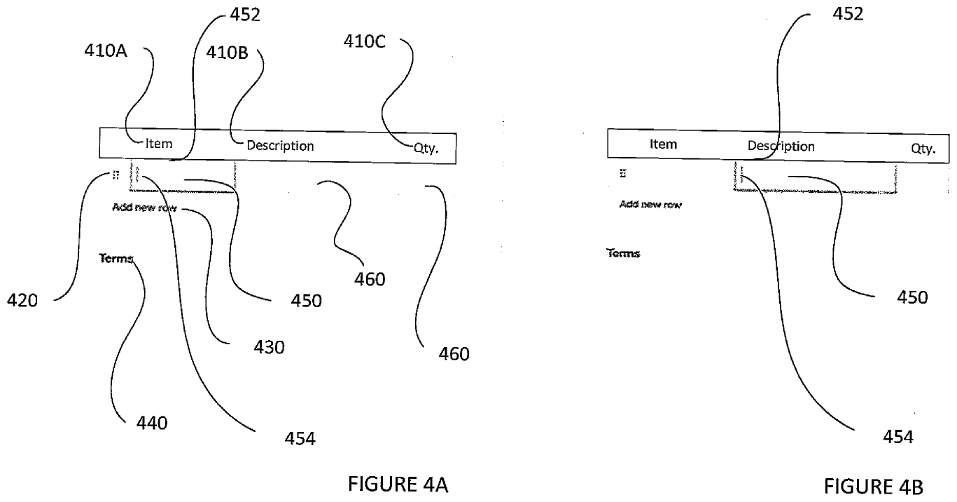

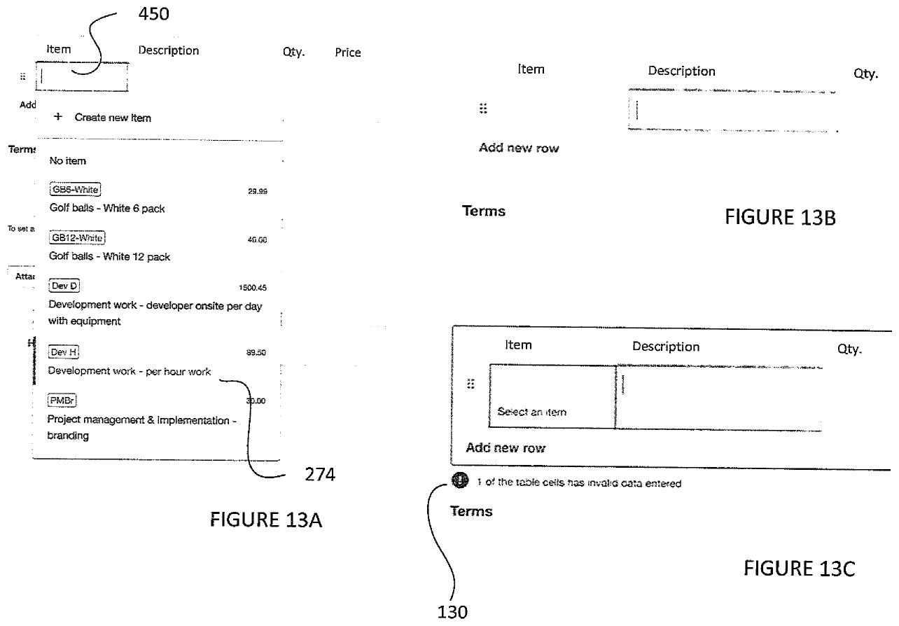

FIG. 4A to 25A illustrate a series of exemplary states of the GUI, and the corresponding FIGS. 4B to 25B (and FIGS. 13C, 23C, and 25C) illustrate updated GUI states following receipt by the GUI and consequent handling of a specific user input. The Figures illustrate excerpts from the GUI to highlight the relevant features, and are not full screenshots. Cells discussed in FIGS. 4A to 25C are autocompleter cells.

In the exemplary state of FIG. 4A, a top section of three columns of a table of cells are shown with respective column headers, Item 410A, Description 410B, and Qty 410C. A selectable icon 420, when selected via user input, enables rows to be switched position with rows above and below, or to be dragged up and down to a new position. Alternatively, a selectable icon may open a menu with options pertaining collectively to the row of data to which the cell currently having focus cell status belongs. A selectable text string 430, equivalent to an icon, when selected via user input, initiates processing to add a new row to the table of cells. The processing may simply add a new blank row to the table of cells, or may present a user interactive form requesting one or more details regarding the new row. A header “Terms” 440 relates to a text box forming part of the GUI but outside of the table of cells.

A cell 450 has focus cell status. It is noted that in the present disclosure the reference sign 450 is linked to the status of the cell rather than the particular cell position within the table of cells. Thus, the reference sign 450 is utilised to refer to a cell having focus cell status, and the reference sign 460 is used to refer to a cell not having focus cell status.

The GUI is configured to indicate a cell having focus cell status 450 from among the table of cells, that is, to make the cell having focus cell status 450 visually distinctive relative to the remaining cells 460. In the example of FIG. 4A, two exemplary visual indicators are used to highlight to a user which of the cells has focus cell status. A first visual indicator 452 is a border 452 of the cell 450 having focus cell status being configured to be visually distinctive with respect to the cells 460. In particular, the border 452 is thicker and darker than the borders of the cells 460. Furthermore, a blinking cursor 454 is rendered within the cell 450 having focus cell status and not in the remaining cells 460. The blinking cursor 454 indicates that the user may input text to the cell. Since the cell 450 is an autocompleter cell, which the GUI has specific rules for handling, input text to the cell 450 has the effect of filtering the population of candidate cell content text strings.

Autocompleter cells are constrained to have cell contents from among members of a defined population of candidate cell content text strings. Therefore, committing a value to the cell (i.e. filling the cell) or updating the value of the cell, may be considered a process of selecting one from the said population (or creating a new member of the said population). Thus, input text to the autocompleter cell 450 is not handled by the GUI as new cell content; rather, it is handled as filtering inputs to filter the population of candidate cell content text strings. The population may be defined on a per column basis. In the example of FIG. 4A, a user account may have a predefined list of items, so that rows in the table of cells must pertain to an item among the list, so that a new row pertaining to an item not already in the list necessarily requires the list to be extended to include the item. Therefore, an autocompleter cell enables a user to select cell content from among the population of candidate cell content text strings, or to create a new item. Wherein a new item is a new member of the population of candidate cell content text strings.

The table of cells may comprise a combination of autocompleter cells and non-autocompleter cells, defined on a per column basis. In the example of FIG. 4A, for example, the column Item may comprise autocompleter cells, whereas the column Qty may comprise non-autocompleter cells. Non-autocompleter cells may accept freeform text or numerical data or any other suitable input type (e.g. checkbox, picklist, etc). An administrator of the table of cells may configure columns of cells to have autocompleter status or non-autocompleter status, or in the example of some tables, the application may have predefined configurations of columns and statuses as autocompleter or non-autocompleter.

The GUI status illustrated in FIG. 4A is exemplary of a state resulting from a user providing a focus cell navigation input via keyboard, such as via tab key or enter key. In particular, a cell 450, which is an autocompleter cell, has focus cell status but the dropdown menu has not opened automatically, in alignment with the example of S310 in FIG. 3.

Whilst the GUI is in the state illustrated in FIG. 4A, a user interacts with the GUI via the keyboard, specifically by a forward tab key press or an enter or return key press. The GUI handles the input as a focus cell navigation input, and so the cell having focus cell status changes to the next cell to the right, as illustrated in FIG. 4B. Furthermore, since the focus cell navigation input was via a keyboard, the dropdown menu does not open automatically, in alignment with the example of S310 in FIG. 3.

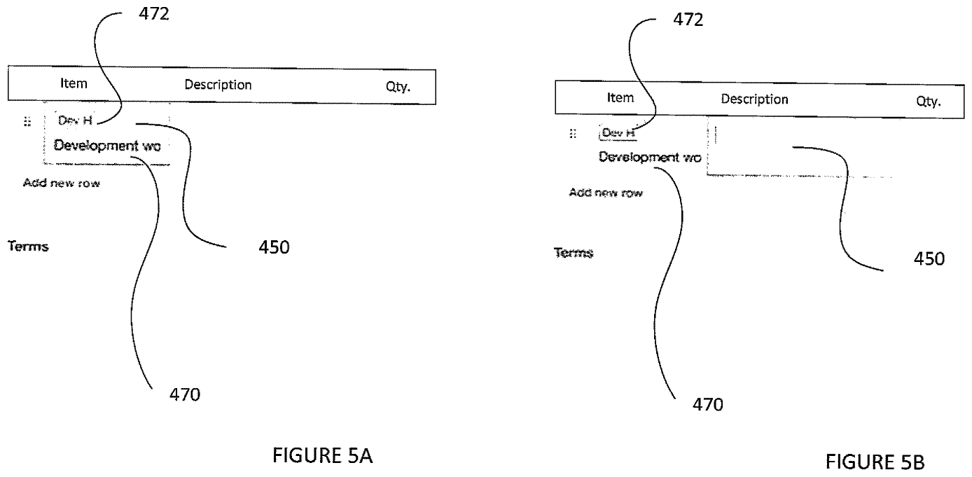

FIG. 5A illustrates a GUI status similar to that of FIG. 4A, with the exception of the cell having focus cell status 450 being filled in FIG. 5A rather than empty in FIG. 4A. Again, the GUI status illustrated in FIG. 5A is exemplary of a state resulting from a user providing a focus cell navigation input via keyboard, such as via tab key or enter key. In particular, a cell 450, which is an autocompleter cell, has focus cell status but the dropdown menu has not opened automatically, in alignment with the example of S310 in FIG. 3.

The cell contents include a cell content text string 470 and a tag 472, wherein tags include additional information about an object represented by the text string. For example, tags may be a categorisation tag indicating which group of objects the object belongs to, or may represent a further property or value of or associated with the object in question, such as a pack size, identifier of a person, etc.

Whilst the GUI is in the state illustrated in FIG. 5A, a user interacts with the GUI via the keyboard, specifically by a forward tab key press or an enter or return key press. The GUI handles the input as a focus cell navigation input, and so the cell having focus cell status changes to the next cell to the right, as illustrated in FIG. 5B. Furthermore, since the focus cell navigation input was via a keyboard, the dropdown menu does not open automatically, in alignment with the example of S310 in FIG. 3. The content of the navigation origination cell remains unchanged, that is, the cell content text string 470 and the tag 472 are not changed by the navigation away.

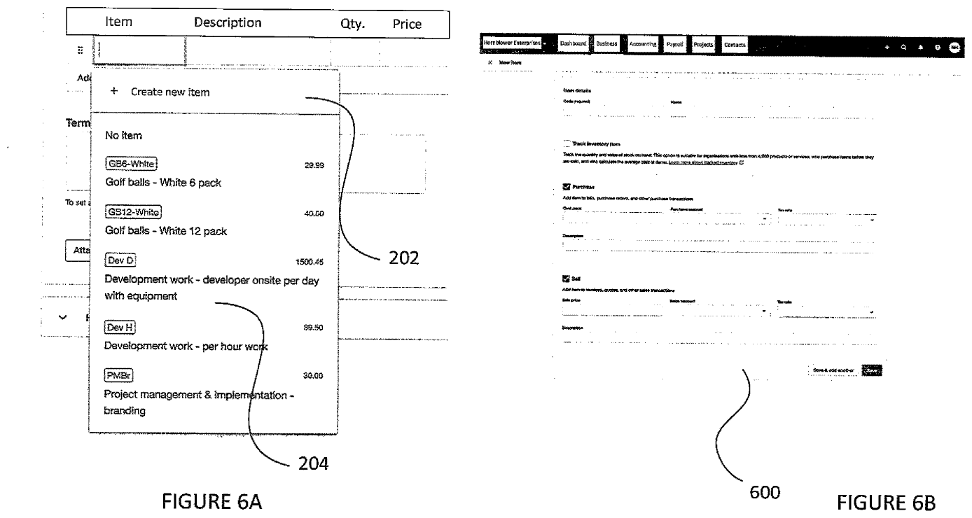

The GUI state illustrated in FIG. 6A is arrived at from the state of FIG. 4A and a user input being received that fulfils the dropdown trigger criteria. In the example of FIG. 6A, the input is a directional down key. From the GUI state illustrated in FIG. 4A, a directional down key press by the user is handled by the GUI as an input satisfying the dropdown trigger criteria, and the dropdown menu 200 opens.

The dropdown menu 200 is as illustrated in FIG. 2B, comprising a first dropdown menu item 202 and a plurality of second dropdown menu items 204, being members of a population of candidate cell content text strings for the Item column, and a third dropdown menu item 206. The menu item that has focus status in this state is the first dropdown menu item 202 by default (i.e. until moved by user inputs).

The first dropdown menu item 202 is a create new item option. A user input via the keyboard such as a tab forward key or enter key from the state of FIG. 6A opens a modal, form or dialog box 600 for creating a new item in the population of candidate cell content text strings. In the example of FIG. 6B, the dialog box is for creation of an object, wherein the new member in the population of candidate cell content text strings is a title or some other reference to the object. In the example of FIG. 6B the dialog box 600 fills the GUI, but it is noted that it may be a pop up or equivalent.

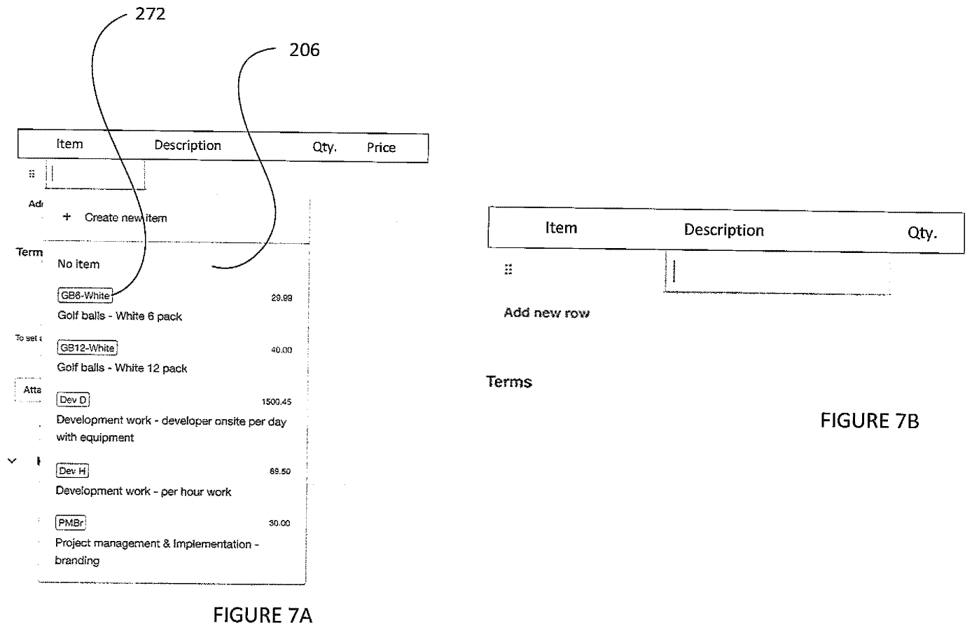

The GUI state illustrated in FIG. 7A is arrived at from the state of FIG. 4A and a user input being received that fulfils the dropdown trigger criteria. In the example of FIG. 7A, the input is a double press of a directional down key. From the GUI state illustrated in FIG. 4A, a directional down key press by the user is handled by the GUI as an input satisfying the dropdown trigger criteria, and the dropdown menu 200 opens. Since the input is specifically a double press, the menu item that has focus state is shifted one position down, from the create new item option, so is on the third dropdown menu item 206 which is the no item, or blank cell, option. Directional up key presses are handled in the same manner but move the focus item status up rather than down.

The dropdown menu 200 is as illustrated in FIG. 2B, comprising a first dropdown menu item 202 and a plurality of second dropdown menu items 204, being members of a population of candidate cell content text strings for the Item column, and a third dropdown menu item. Owing to the double press of the directional down key from the state of FIG. 4A, the menu item having focus status in this state is the third dropdown menu item 206.

In FIGS. 6A and 7A, the menu item having focus item status is indicated by a background highlight of the menu item having focus status relative to the remaining menu items. Furthermore, it is noted that categorisation labels or tags 272 are included in the second dropdown menu items. Tags 272 may be referred to as labels or further information fields.

From the GUI state illustrated in FIG. 7A, a further user input via the forward tab key or enter key leads to the state illustrated in FIG. 7B. The said user input is handled by the GUI as a focus cell navigation input from origin cell to destination cell, and a commit input to commit menu item having focus item status to the cell (having focus cell status).

The “no item” option is selected and so the focus cell navigation origin cell is left blank and the cell having focus cell status is moved one cell to the right in the same row.

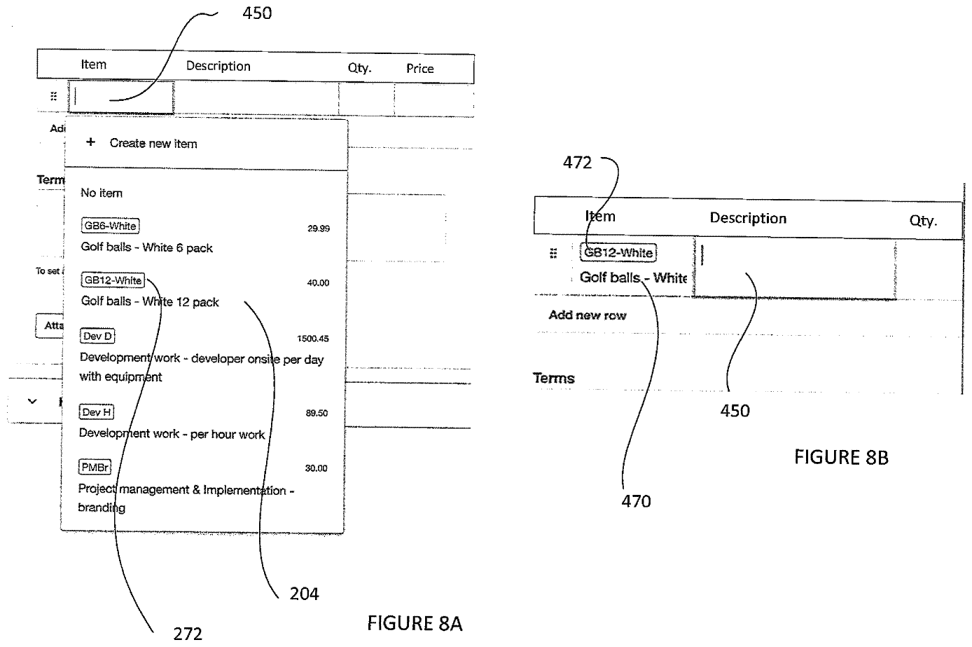

The GUI state illustrated in FIG. 8A is arrived at from the state of FIG. 4A and a user input being received that fulfils the dropdown trigger criteria. In the example of FIG. 8A, the input is more than two presses of a directional down key. From the GUI state illustrated in FIG. 4A, a directional down key press by the user is handled by the GUI as an input satisfying the dropdown trigger criteria, and the dropdown menu 200 opens. Since the input is specifically more than two presses, the menu item that has focus state is shifted over the first dropdown menu item 202, over the third dropdown menu item 206, and into the second dropdown menu items 204. Directional up key presses are handled in the same manner but move the focus item status up rather than down.

From the GUI state illustrated in FIG. 8A, a further user input via the forward tab key or enter key leads to the state illustrated in FIG. 8B. The said user input is handled by the GUI as a focus cell navigation input from origin cell to destination cell, and a commit input to commit menu item having focus item status to the cell (having focus cell status), in accordance with S306. The candidate cell content text string “Golf Balls-White 12 pack” option is selected and so the text string 204 and its associated tag 272 are committed to the focus cell and the cell having focus cell status is then moved one cell to the right in the same row, as illustrated in FIG. 8B, in accordance with S308. In FIG. 8B, it can be seen that the cell contents of the origin cell include a cell content text string 470 and a tag 472.

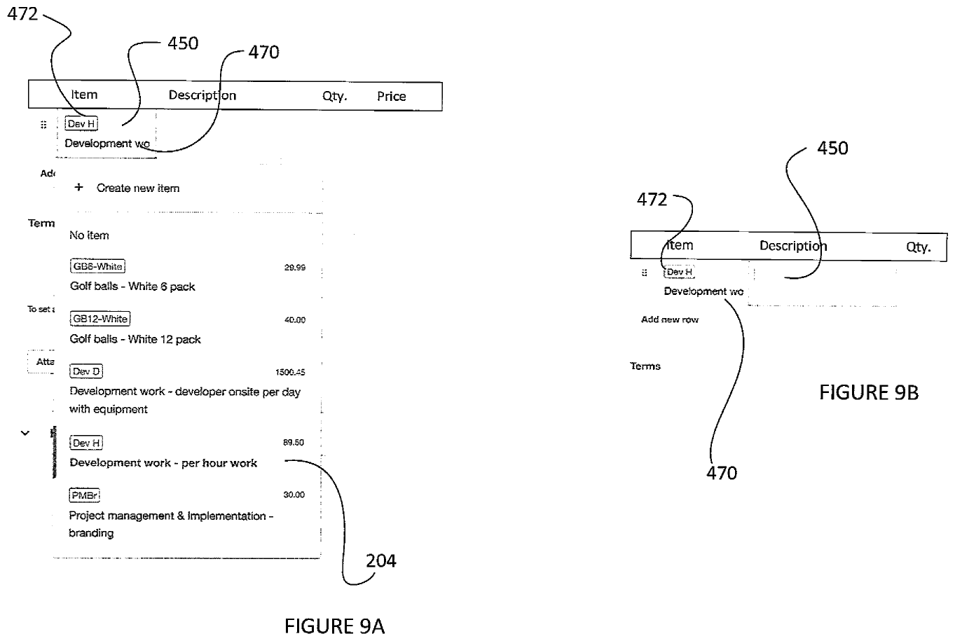

FIG. 9A illustrates a GUI state in which a user has navigated using tab or enter key into a cell 450 to give that cell focus cell status, and the cell already has content in the form of a text string 470 and optional tag 472. That is, a member of the population of candidate cell content text strings has previously been committed to the cell, or the cell is pre-loaded with the said content. In the GUI state illustrated in FIG. 9A during a time in which the cell 450 has focus cell status (the cell being an autocompleter cell), a user input is received by the GUI that fulfils the dropdown trigger criteria. In the example of FIG. 9A, the input is a directional down key press. A directional down key press by the user is handled by the GUI as an input satisfying the dropdown trigger criteria, and the dropdown menu 200 opens with the current cell content having focus item status. In the example of FIG. 9A focus item status is indicated by a background highlighted for the space in the dropdown menu occupied by the item, and a menu item corresponding to cell content at a time of opening the dropdown menu is indicated by a different highlighting technique, in this case a font colour distinct from the font colour used for all of the remaining menu items. Directional up key presses, being opposing to the direction in which a dropdown menu drops, are not handled as inputs satisfying the dropdown trigger criteria. Directional up key presses navigate the dropdown menu item having focus item status while the dropdown menu is open, but cannot cause the dropdown menu to open.

Should a screen reader be active while a user is entering a text string to the autocompleter cell, the GUI is configured so that the screen reader outputs as voice audio, while the user is entering the text string, the character newly added to the string, the number of members of the population of candidate cell content text strings remaining after filtering according to the text string, and the menu item currently having focus item status.

FIG. 9B illustrates how the GUI handles a user input via tab key or enter key from the state illustrated in FIG. 9A. The said user input is handled by the GUI as a focus cell navigation input from origin cell to destination cell, and a commit input to commit menu item having focus item status to the cell (having focus cell status), in accordance with S306. The candidate cell content text string is the present text string and so the cell contents of the focus cell are unchanged with respect to the cell contents at the time of opening the dropdown menu, and the cell having focus cell status is then moved one cell to the right in the same row, as illustrated in FIG. 9B. The move is to an autocompleter cell but as set out in S310 the dropdown menu is not opened unless or until an input satisfying dropdown trigger criteria is received.

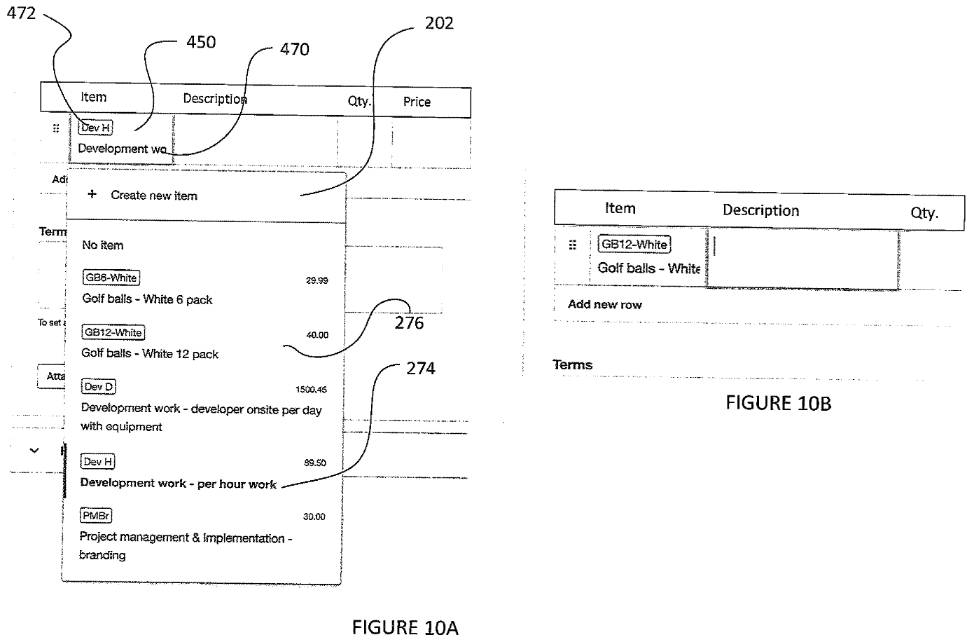

FIG. 10A illustrates a GUI state in which a user has navigated using tab or enter key into a cell 450 to give that cell focus cell status, and the cell already has content in the form of a text string 470 and optional tag 472. In the GUI state illustrated in FIG. 10A during a time in which the cell 450 has focus cell status (the cell being an autocompleter cell), a user input is received by the GUI that fulfils the dropdown trigger criteria. In the example of FIG. 10A, the input is a directional down key press followed up by more than one directional up key press (specifically two directional up key presses in the example of FIG. 10A). A directional down key press when the dropdown menu is not open is handled by the GUI as an input satisfying the dropdown trigger criteria, and the dropdown menu 200 opens with the dropdown menu item corresponding to the present cell content having focus item status. The subsequent two directional up key presses are handled by the GUI as inputs navigating the dropdown menu item having focus item status up two items. Should plural directional up key presses be input and received by the GUI following a directional down key press or any other user input satisfying the dropdown trigger criteria, the directional up key presses have the effect of moving the menu item having focus item status upward away from the current cell content having focus item status. In the example of FIG. 10A, the menu item 274 corresponding to cell content at a time of opening the dropdown menu is indicated by a font colour distinct from the font colour used for all of the remaining menu items. The menu item having focus item status 276 is indicated by a background colour for the dropdown menu space occupied by said menu item being distinct from a background colour used for all of the remaining menu items. In the dropdown menu 200 illustrated in FIG. 10A, the first dropdown menu item 202 “create new item” is always present as a menu item while the dropdown menu 200 is open.

FIG. 10B illustrates how the GUI handles a user input via tab key or enter key from the state illustrated in FIG. 10A. The said user input is handled by the GUI as a focus cell navigation input from origin cell to destination cell, and a commit input to commit menu item having focus item status 276 to the cell (having focus cell status), in accordance with S306. The candidate cell content text string is the text string 276 and so the cell contents of the focus cell 450 of FIG. 10A are updated with respect to the cell contents at the time of opening the dropdown menu, and the cell having focus cell status is then moved one cell to the right in the same row, as illustrated in FIG. 10B. The move is to an autocompleter cell but as set out in S310 the dropdown menu is not opened unless or until an input satisfying dropdown trigger criteria is received.

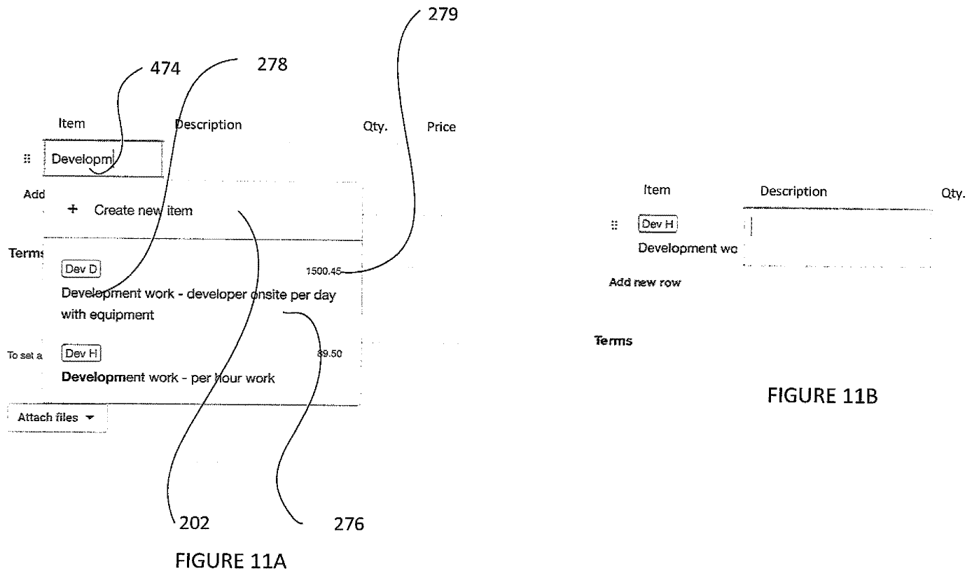

FIG. 11A illustrates a GUI state in which an autocompleter cell has focus cell status, and wherein text string characters are entered into the cell via a keyboard input mechanism, being either key presses of alphanumeric character keys or a paste action. A first entry of any text string character satisfies the dropdown trigger criteria and the dropdown opens, the input text string character is displayed in the cell 450. Text string characters input to a cell are received by the GUI as filtering inputs, and filter the population of candidate cell content text strings from the full population to a filtered subset thereof, wherein the second dropdown menu items are the filtered subset if space allows, or a scrollable subset if space does not allow. Term dynamic subset is employed in the present disclosure to refer to the filtered subset present in the dropdown menu 200, which is all of the filtered subset if space allows or a scrollable subset of the filtered subset if space does not allow. In the example of FIG. 11A, several text string characters 474 are entered into the cell 450. A text highlighting technique is used to highlight portions of second dropdown menu items 278 in common with the filtering inputs 474. Noting that all members of the population of candidate cell content text strings not containing the filtering input text string 474, are excluded from the dropdown menu 200. Focus item status 276 belongs to a top position among the filtered subset, wherein positions are defined by an ordering metric such as alphabetical order. In the dropdown menu 200 illustrated in FIG. 11A, the first dropdown menu item 202 “create new item” is always present as a menu item while the dropdown menu 200 is open.

Optionally, menu items in the dropdown menu 200 include further information 279, being a property of the object represented by the corresponding text string.

FIG. 11B illustrates how the GUI handles a user input via tab key or enter key from the state illustrated in FIG. 11A. The said user input is handled by the GUI as a focus cell navigation input from origin cell to destination cell, and a commit input to commit menu item having focus item status 276 to the cell (having focus cell status), in accordance with S306. The candidate cell content text string is the text string 276 and so the cell contents of the focus cell 450 of FIG. 11A are updated to contain the full text string of the dropdown menu item, and not merely the filtering input text string (as illustrated in FIG. 11A), and the cell having focus cell status is then moved one cell to the right in the same row. The move is to an autocompleter cell but as set out in S310 the dropdown menu is not opened unless or until an input satisfying dropdown trigger criteria is received.

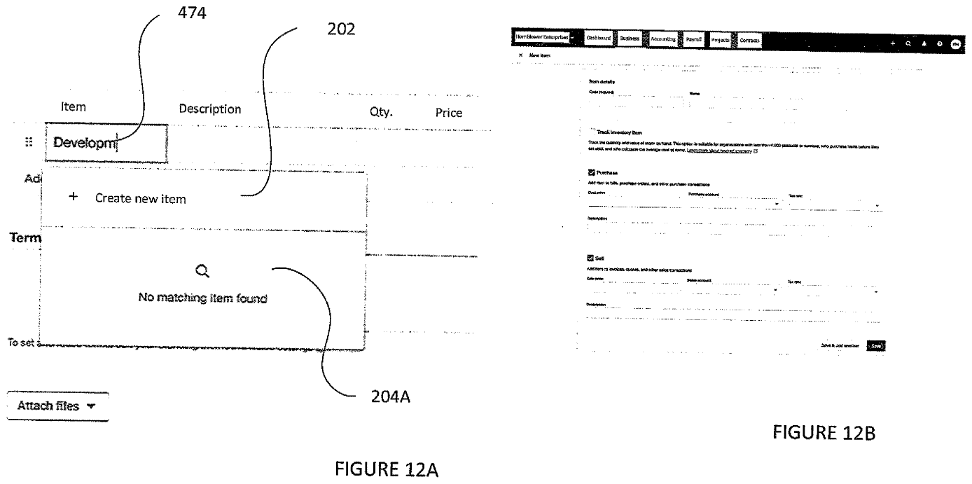

FIG. 12A illustrates a GUI state in which an autocompleter cell has focus cell status, and wherein text string characters are entered into the cell via a keyboard input mechanism, being either key presses of alphanumeric character keys or a paste action. The filtering input text string 474 and the handling thereof is as per FIG. 11A described above, however in the example of FIG. 12A there are no members of the population of candidate cell content text strings that contain the filtering input text string 474. In this case, the dropdown menu space usually occupied by the dynamic subset of second dropdown menu items 204 is replaced by an indicator 204A that there are no members of the population of candidate cell content text strings that contain the filtering input text string 474. The only remaining selectable item in the dropdown menu 200 is the first dropdown menu item 202, which is always present in the dropdown menu 200 while open. Accordingly, the first dropdown menu item 202 has focus item status, as indicated by the background highlight.

FIG. 12B illustrates how the GUI handles a user input via tab key or enter key from the state illustrated in FIG. 11A. In that case, since create new item has focus item status at time or receipt of the said user input, the create new item dialog 600 opens. Optionally, the relevant field of the dialog box imports the filtering input text string 474 from the GUI state illustrated in FIG. 12A.

FIG. 13A illustrates a GUI state in which a user has navigated focus cell status into a cell 450, the cell being autocompleter cell, and the user has then deleted cell content present at the time of navigating the focus cell status to the cell. Said deletion being via a delete key, backspace key presses, or some other means. The delete key press or first of the backspace key presses is an input fulfilling a dropdown trigger criteria, being an interaction with the cell, and so the dropdown menu 200 opens. A menu item 274 is highlighted using the differentiated font colour technique to indicate that the menu item corresponds to cell content of the focus cell at a time of opening the dropdown menu. No menu item has focus item status.

FIGS. 13B & 13C illustrate how the GUI handles a user input via tab key or enter key from the state illustrated in FIG. 13A. In the case illustrated in FIG. 13B, the cell 450 belongs to a column which is designated as not requiring a value, and so the cell remains empty and the focus cell is navigated one cell to the right. In the case illustrated in FIG. 13C, the cell 450 belongs to a column which is designated as requiring a value, and so the cell remains empty, the focus cell is navigated one cell to the right, and the cell is highlighted with a border indicating an error, and an alert indicator 130 is displayed.

In any example in the present disclosure, should a screen reader be active while the alert indicator 130 is displayed, the GUI is configured so that the screen reader outputs as voice audio a message communicating the alert to the user as voice audio.

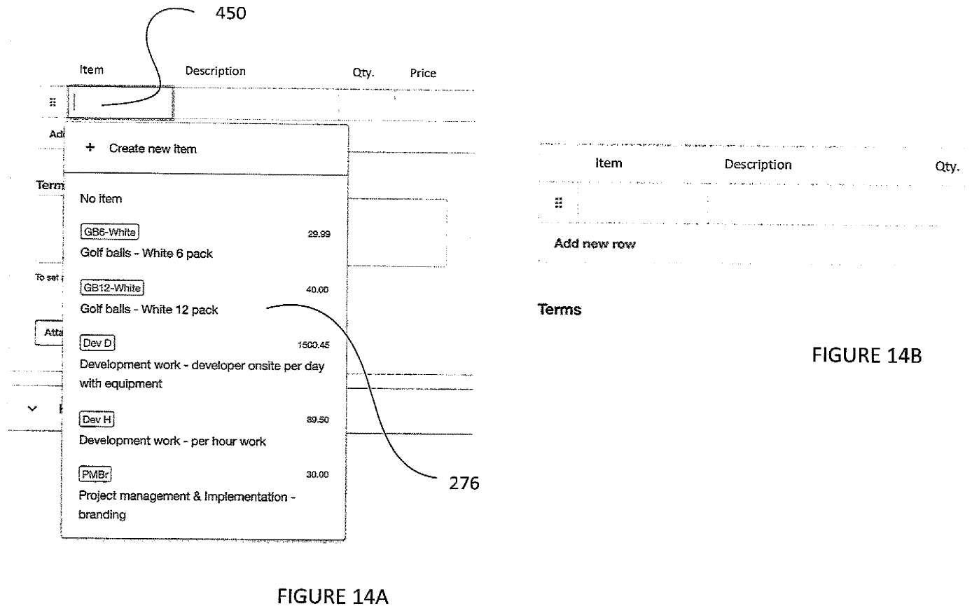

FIG. 14A illustrates a GUI state in which a cell 450 has focus cell status and the dropdown trigger criteria is fulfilled. The focus cell 450 is an autocompleter cell. Noting that if the focus cell navigation to the cell 450 was via a cursor moving device and selection, then the said focus cell navigation itself would fulfil the dropdown trigger criteria, whereas keyboard-based focus cell navigation would require a further input such as a directional up or down key press to fulfil the dropdown trigger criteria. The cell 450 is blank at a time of obtaining focus cell status. Either by cursor hover or by directional up and down keys, the dropdown menu item having focus item status 276 is highlighted by the differential background colour technique.

FIG. 14B illustrates how the GUI handles a user input via a cursor moving device including a selector input (i.e. click) at a location away from the dropdown menu of FIG. 14A. As set out at S316, the said user input is handled as a focus cell navigation input and changes cell having focus cell status according to the location of the selector input. Furthermore, FIG. 14B shows that as set out in S314B, the focus cell 450 of FIG. 14A receives the blank filtering text input.

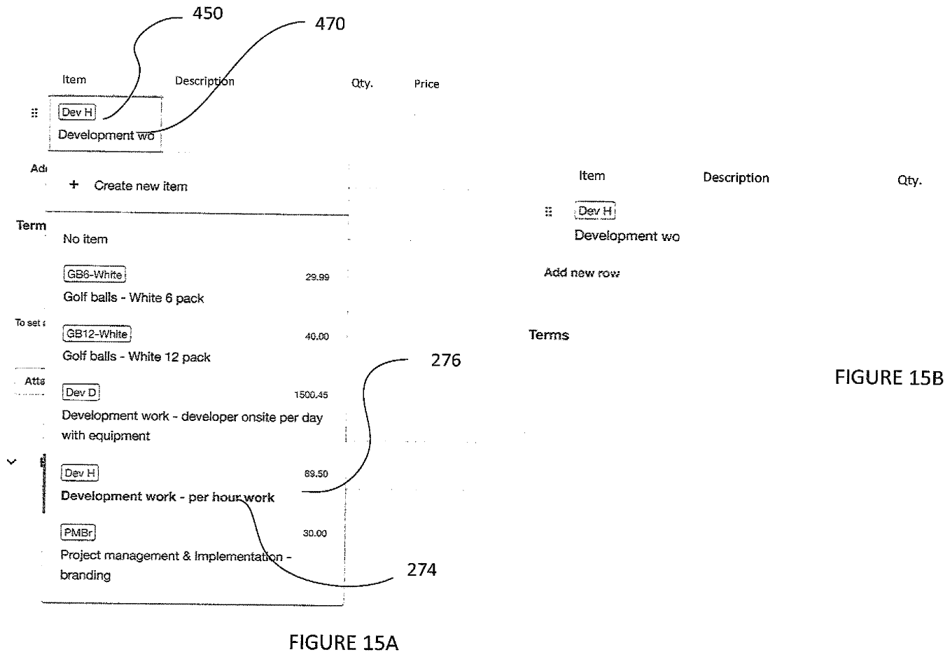

FIG. 15A is equivalent to the state illustrated in FIG. 9A. Noting in particular that the focus cell 450 has content at a time of obtaining focus cell status, as indicated by the cell content 470 and the differential font colour technique 274 at the corresponding dropdown menu item. Differential background highlighting technique 276 within the dropdown menu 200 indicates that the menu item corresponding to the cell content already committed to the cell has focus item status.

FIG. 15B illustrates a GUI state after the GUI handles a user input via a cursor moving device including a selector input (i.e. click) at a location away from the dropdown menu of FIG. 15A. As set out at S316, the said user input is handled as a focus cell navigation input and changes cell having focus cell status according to the location of the selector input. Furthermore, FIG. 15B shows that the cell content of the focus cell 450 of FIG. 15A is unchanged relative to an instant of opening the dropdown menu 200.

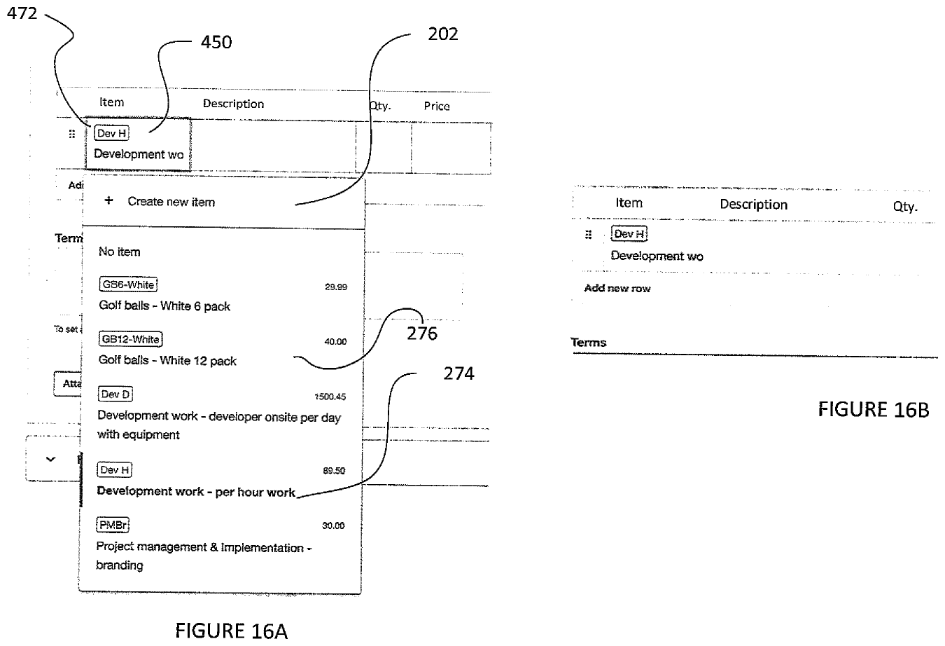

FIG. 16A is equivalent to the state shown in FIG. 10A. In particular, it is noted that the focus cell 450 has content at a time of obtaining focus cell status, as indicated by the cell content 470 and the differential font colour technique 274 at the corresponding dropdown menu item. Differential background highlighting technique 276 within the dropdown menu 200 indicates that a menu item other than that corresponding to the cell content already committed to the cell has focus item status.

FIG. 16B illustrates a GUI state after the GUI handles a user input via a cursor moving device including a selector input (i.e. click) at a location away from the dropdown menu of FIG. 16A. As set out at S316, the said user input is handled as a focus cell navigation input and changes cell having focus cell status according to the location of the selector input. Furthermore, FIG. 16B shows that the cell contents of the focus cell 450 of FIG. 16A is unchanged relative to an instant of opening the dropdown menu 200.

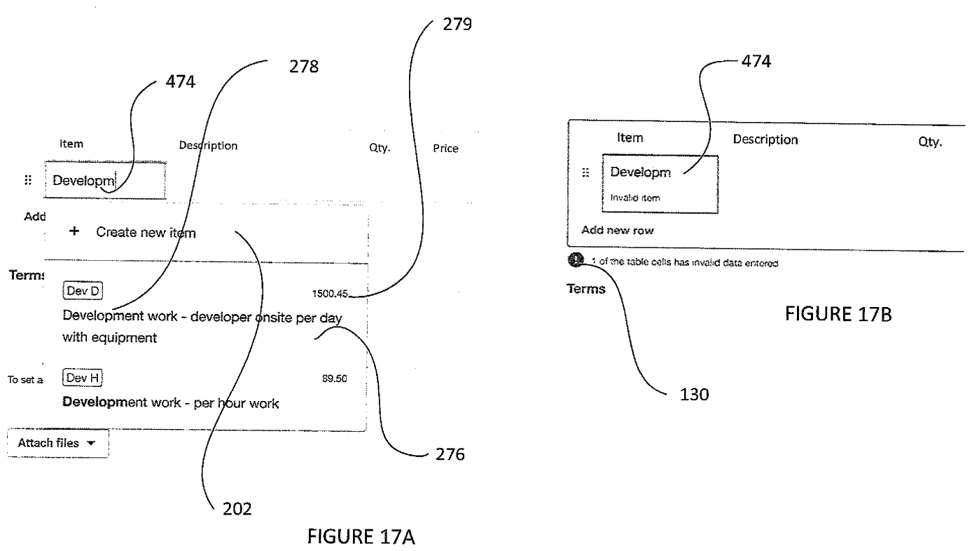

FIG. 17A is equivalent to the state shown in FIG. 11A. In particular, it is noted that the focus cell 450 has obtained focus cell status and that a user has entered a filtering input string 474, either by alphanumeric character keypresses on a keyboard or by a paste action. The paste action or the first alphanumeric keypress fulfilled the dropdown trigger criteria, and the dropdown menu is opened with a dynamic subset resulting from the filtering of the population of candidate cell content text strings according to the filtering input string 474. As illustrated in FIG. 17A, focus item status within the dropdown menu 200 has leapfrogged the first dropdown menu item 202 “create new item” and instead a top menu item among the dynamic subset (or filtered subset) has focus item status.

FIG. 17B illustrates a GUI state after the GUI handles a user input via a cursor moving device including a selector input (i.e. click) at a location away from the dropdown menu of FIG. 17A. The filtering input text string 474 remains in the cell but the GUI runs a validation test on the cell content which the filtering input text string 474 fails because it is not a unique member of the population of candidate cell content text strings (or blank if blank is allowable). Thus, FIG. 17B shows that the focus cell 450 of FIG. 17A is bordered with a colour highlighting an error within the cell, and a warning indicator 130 highlights to a user that the cell content is invalid.

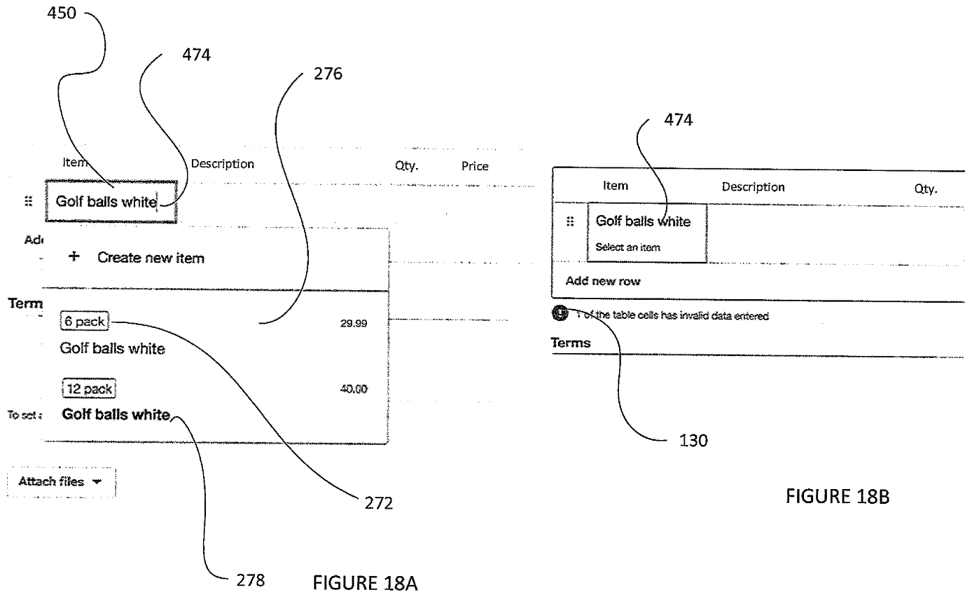

FIG. 18A illustrates a GUI state in which the focus cell 450 has obtained focus cell status and a user has entered a filtering input string 474, either by alphanumeric character keypresses on a keyboard or by a paste action. The paste action or the first alphanumeric keypress fulfilled the dropdown trigger criteria, and the dropdown menu is opened with a dynamic subset resulting from the filtering of the population of candidate cell content text strings according to the filtering input string 474. As illustrated in FIG. 18A, focus item status within the dropdown menu 200 has leapfrogged the first dropdown menu item 202 “create new item” and instead a top menu item among the dynamic subset (or filtered subset) has focus item status. In the state shown in FIG. 18A, two second dropdown menu items both have text strings containing (in this example exactly matching) the filtering input text string 474, as indicated by the bold text 278 used for the text strings of the dropdown menu items. A tag or further information field distinguishes the objects represented by the remaining second dropdown menu items from one another.

FIG. 18B illustrates a GUI state after the GUI handles a user input via a cursor moving device including a selector input (i.e. click) at a location away from the dropdown menu of FIG. 18A. The filtering input text string 474 remains in the cell but the GUI runs a validation test on the cell content which the filtering input text string 474 fails because it is not a unique member of the population of candidate cell content text strings (or blank if blank is allowable). Thus, FIG. 18B shows that the focus cell 450 of FIG. 18A is bordered with a colour highlighting an error within the cell, and a warning indicator 130 highlights to a user that the cell content is invalid. In the example of FIG. 18B, clicking away maintains the cell content at the time of opening the dropdown menu because with multiple second dropdown menu items remaining the GUI cannot assume which a user intends for the cell, regardless of focus item status.

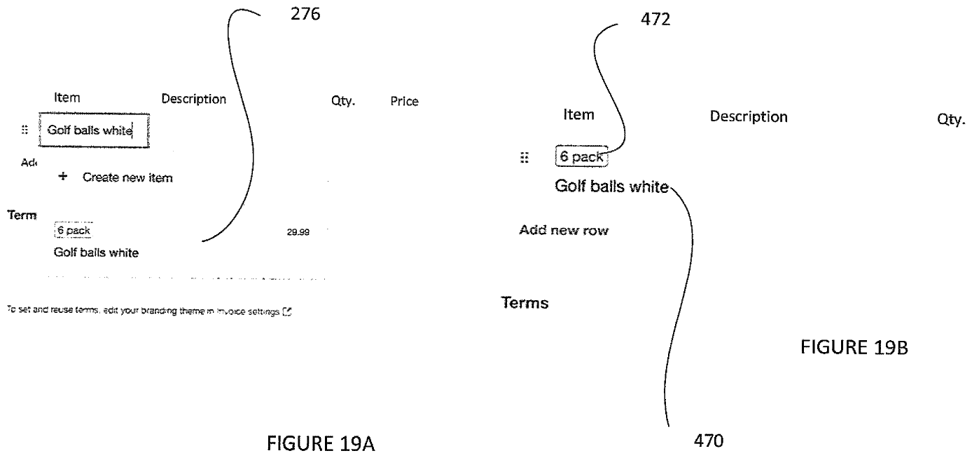

FIG. 19A illustrates a GUI state equivalent to that of FIG. 18A, with the exception of there being only a single member of the population of candidate cell content text strings that exactly matches or contains the filtering input text string. In this case, the number of remaining second dropdown menu items is one, i.e. the dynamic subset has only one member, the filtering of the population of candidate cell content text strings has reduced the number to one, which therefore has focus item status as indicated by background highlighting 276.

FIG. 19B illustrates a GUI state after the GUI handles a user input via a cursor moving device including a selector input (i.e. click) at a location away from the dropdown menu of FIG. 19A. The filtering input text string 474 remains in the cell and the GUI runs a validation test on the cell content which the filtering input text string 474 passes because it is a unique member of the population of candidate cell content text strings (or blank if blank is allowable). This is a YES at step S312 of FIG. 3. Thus, as at S314A, FIG. 19B shows that the focus cell 450 of FIG. 19A has content updated as per the text string of the unique member of the population of candidate cell content text strings. In the example of FIG. 19B, clicking away updates the cell content because with only a single second dropdown menu item remaining the GUI can assume which a user intends for the cell, regardless of focus item status. Other details of the object represented by the text string such as a tag 472 are also included in the cell.

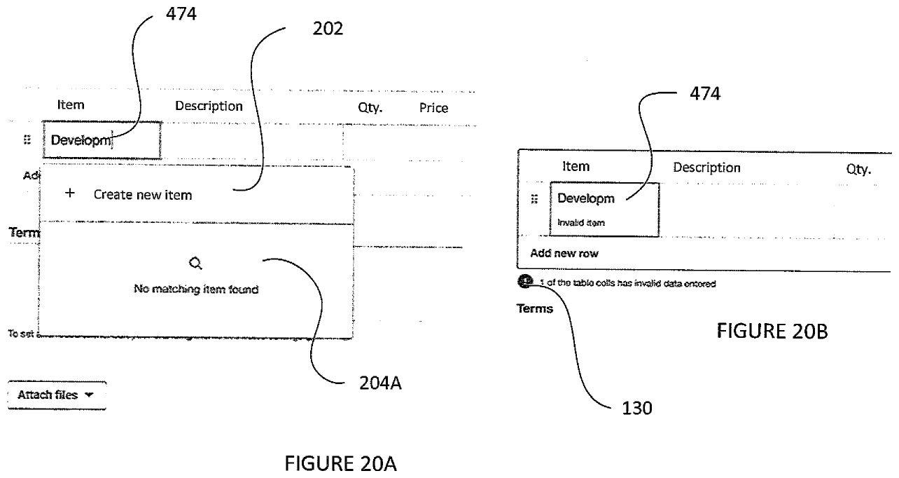

FIG. 20A is equivalent to the state illustrated in FIG. 12A. No matching item is found for the filtering input text string 474. That is, the entirety of the population of candidate cell content text strings has been filtered out.

FIG. 20B illustrates a GUI state after the GUI handles a user input via a cursor moving device including a selector input (i.e. click) at a location away from the dropdown menu of FIG. 20A. The filtering input text string 474 remains in the cell but the GUI runs a validation test on the cell content which the filtering input text string 474 fails because it is not a unique member of the population of candidate cell content text strings (or blank if blank is allowable). Thus, FIG. 20B shows that the focus cell 450 of FIG. 20A is bordered with a colour highlighting an error within the cell, and a warning indicator 130 highlights to a user that the cell content is invalid.

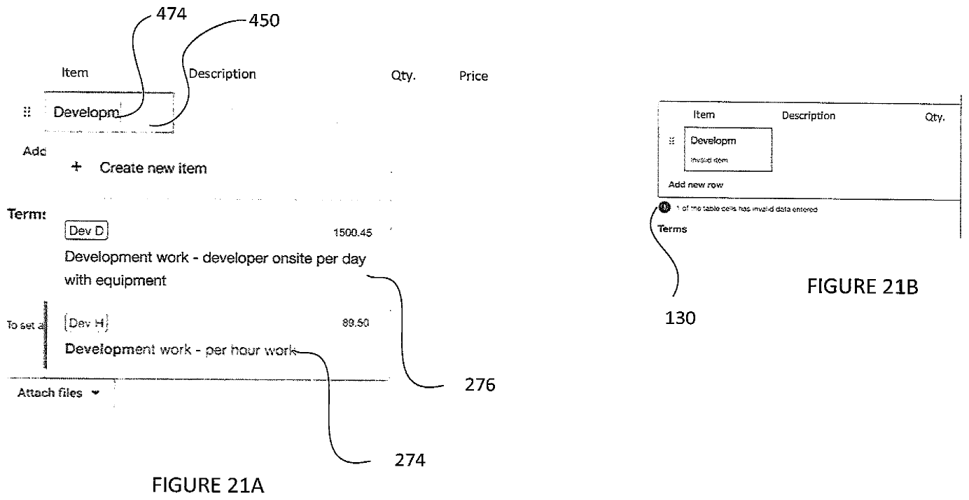

FIG. 21A illustrates a GUI state in which there was existing cell content at an instant when cell 450 obtained focus cell status (i.e. was navigated into via a user input). The second dropdown menu item corresponding to the cell content at said instant is indicated by the differential font colour 274 in the dropdown menu 200. User inputs a filtering input text string either positively, by pasting in or entering alphanumeric characters from a keyboard, or negatively by backspacing to remove characters from the existing cell content text string. In all examples, the dynamic subset updates as the filtering input string 474 changes. At the instant shown in FIG. 21A, there are two members of the population of candidate cell content text strings containing the filtering input string 474. Thus, there are two members of the dynamic subset. One has focus item status, which has automatically bypassed the first dropdown menu item “create new item” so that a top-most of the dynamic subset members has focus item status, as indicated by the differential background colour 276.

FIG. 21B illustrates a GUI state after the GUI handles a user input via a cursor moving device including a selector input (i.e. click) at a location away from the dropdown menu of FIG. 21A. The determination at S312 would be no, because there are two members of the dynamic subset not one, and so the flow proceeds to step S314B. The filtering input string remains in the cell but the cell is invalidated, as indicated by warning indicator 130 and coloured border. Coloured border may be, for example, red.

A filtering input string is a text string in the cell having focus cell status. It is used by the GUI to filter the population of candidate cell content text strings. The filtering results are displayed in the dropdown menu as second dropdown menu items, below the first dropdown menu item.

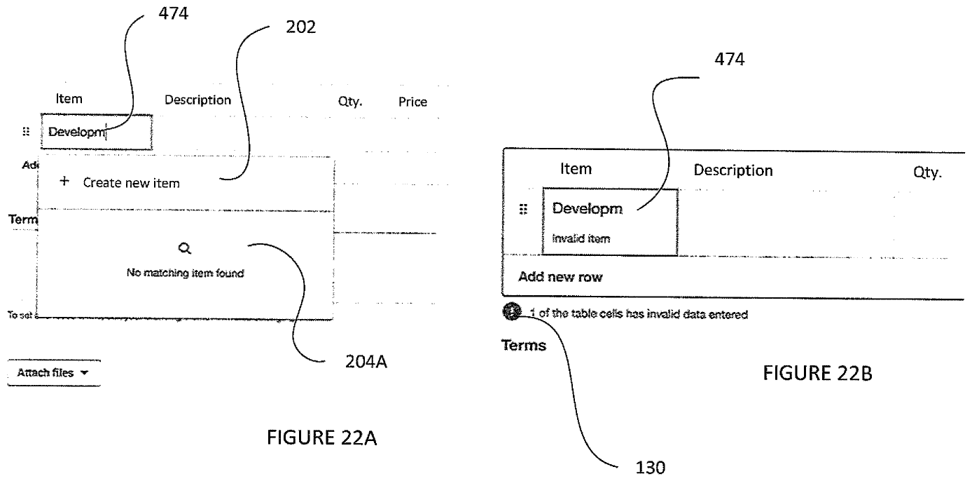

FIG. 22A is equivalent to the state illustrated in FIG. 12A. No matching item is found for the filtering input text string 474. That is, the entirety of the population of candidate cell content text strings has been filtered out. In the example of FIG. 22A, there was cell content at a time of the cell obtaining focus cell status, whereas in the example of FIG. 20A the cell was empty at a time of obtaining focus cell status. Nonetheless, as indicated in FIG. 22B, the consequence of a selector input (i.e. click) at a location away from the dropdown menu of FIG. 22A is the filtering input string 474 remaining in the cell and the cell content failing a validation test.

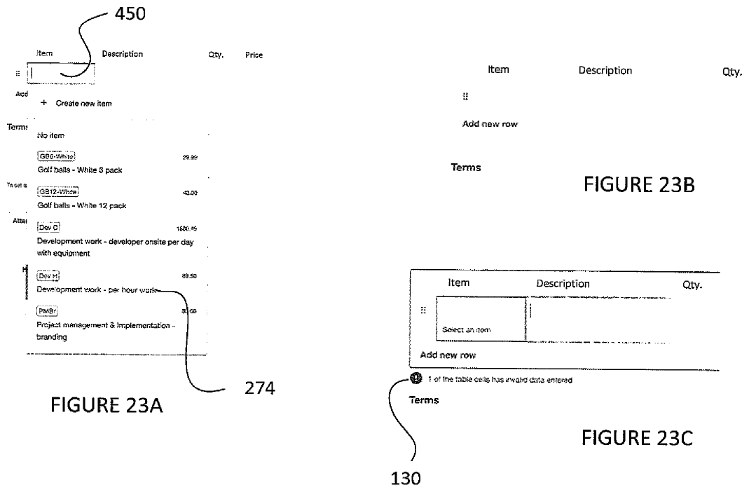

FIG. 23A illustrates a GUI state in which a user has navigated focus cell status into a cell 450, the cell being an autocompleter cell, and the user has then deleted cell content present at the time of navigating the focus cell status to the cell. Said deletion being via a delete key, backspace key presses, or some other means. The delete key press or first of the backspace key presses is an input fulfilling a dropdown trigger criteria, being an interaction with the cell, and so the dropdown menu 200 opens. A menu item 274 is highlighted using the differentiated font colour technique to indicate that the menu item corresponds to cell content of the focus cell at a time of opening the dropdown menu. No menu item has focus item status.

In this case, as illustrated in FIG. 23B, clicking away maintains the filtering input text string (i.e. blank) as per S314A or S314B. Whether or not the cell passes validation depends on configuration of the application or the specific table. Certain tables, or even columns, may be configured to allow blank cells, certain may not be. FIG. 23B shows an example in which the column is configured to allow blank cells, whereas FIG. 23C shows an example in which the blank cell fails the validation text by the GUI and so a warning 130 is displayed.

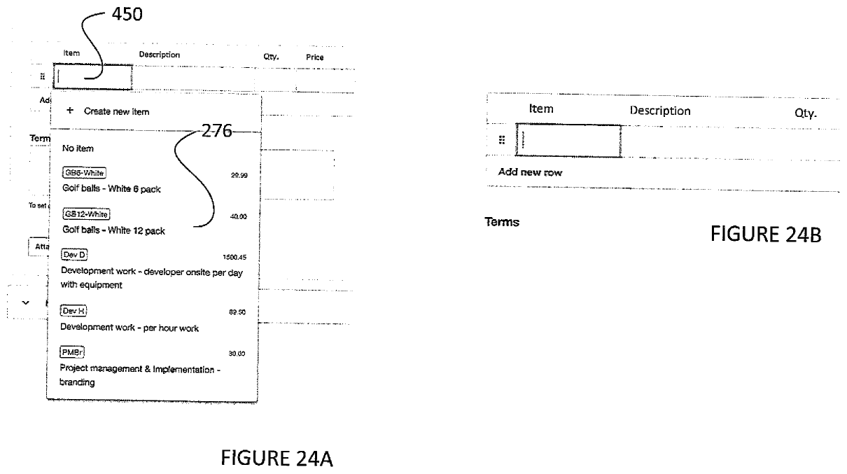

FIG. 24A illustrates an empty cell 450 into which a user has navigated the focus cell status. The dropdown trigger criteria has been fulfilled, and an item having focus item status is indicated by differential background rendering 276 for the area of the dropdown menu occupied by the menu item. Focus item status within the dropdown menu may be changed via cursor hover from cursor moving devices or directional up and down key presses.

FIG. 24B illustrates how the GUI handles a key press of an escape key of a keyboard, from the state illustrated in FIG. 24A. The GUI responds to the escape keypress by closing the dropdown menu 200, but the cell 450 retains focus cell status, and the cell remains blank or empty.

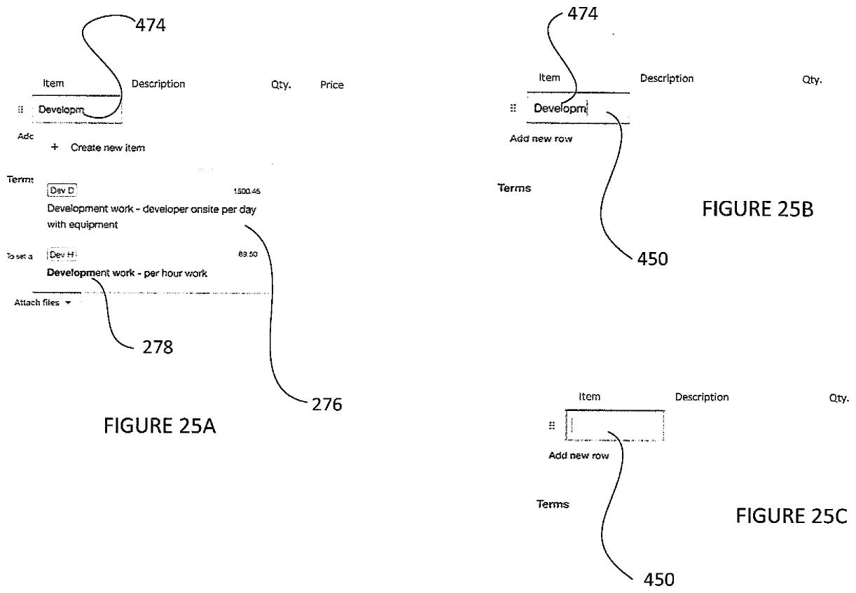

FIG. 25A is equivalent to the state shown in FIG. 11A. In particular, it is noted that the focus cell 450 has obtained focus cell status and that a user has entered a filtering input string 474, either by alphanumeric character keypresses on a keyboard or by a paste action. The paste action or the first alphanumeric keypress fulfilled the dropdown trigger criteria, and the dropdown menu is opened with a dynamic subset resulting from the filtering of the population of candidate cell content text strings according to the filtering input string 474. As illustrated in FIG. 25A, focus item status within the dropdown menu 200 has leapfrogged the first dropdown menu item 202 “create new item” and instead a top menu item among the dynamic subset (or filtered subset) has focus item status.

FIG. 25B illustrates a consequence of an escape key press from the state illustrated in FIG. 25A. Escape key press is interpreted by the GUI as a negative input and so no dropdown menu item is selected to commit to the cell, regardless of focus item status. Rather, the cell 450 retains focus cell status and contains the filtering input text string 474.

FIG. 25C illustrates a consequence of an escape key press from the state illustrated in FIG. 25B. The escape key press clears the filtering input string 474 from the cell 450. Cell 450 retains focus cell status.

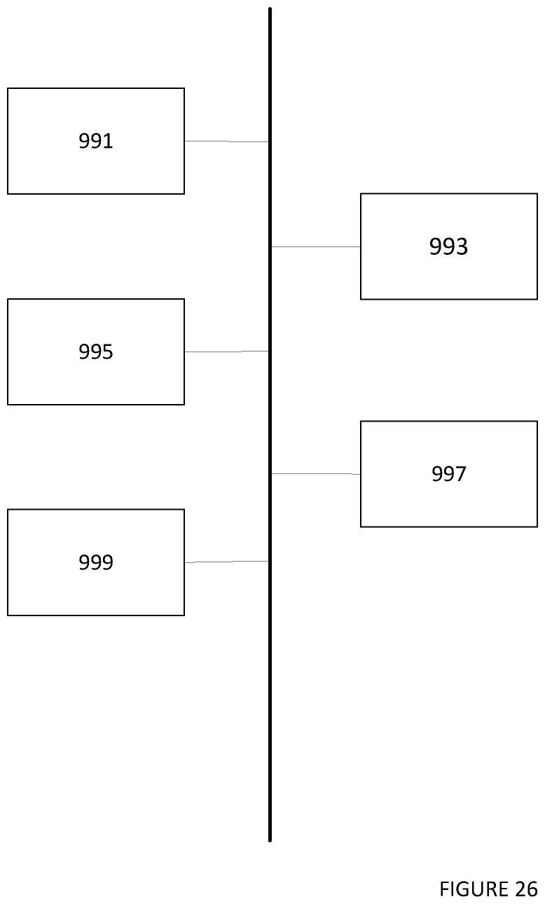

FIG. 26 is a schematic illustration of a hardware arrangement of a computing apparatus. The user device and/or the server such as the web server may be implemented by apparatus having an arrangement such as illustrated in FIG. 26.

The computing apparatus comprises a plurality of components interconnected by a bus connection. The bus connection is an exemplary form of data and/or power connection. Direct connections between components for transfer of power and/or data may be provided in addition or as alternative to the bus connection.

The computing apparatus comprises memory hardware 991 and processing hardware 993, which components are essential regardless of implementation. Further components are context-dependent, including a network interface 995, input devices 997, and a display unit 999. The display unit 999 and the processing hardware 993 may cooperate to implement a graphical user interface.

The memory hardware 991 stores processing instructions for execution by the processing hardware 993. The memory hardware 991 may include volatile and/or non-volatile memory. The memory hardware 991 may store data pending processing by the processing hardware 993 and may store data resulting from processing by the processing hardware 993.

The processing hardware 993 comprises one or a plurality of interconnected and cooperative CPUs for processing data according to processing instructions stored by the memory hardware 991.

Implementations may comprise one computing device according to the hardware arrangement of FIG. 26, or a plurality of such devices operating in cooperation with one another. For example, in a client: server arrangement.

A network interface 995 provides an interface for transmitting and receiving data over a network. Connectivity to one or more networks is provided. For example, a local area network and/or the internet. Connectivity may be wired and/or wireless.

Input devices 997 provide a mechanism to receive inputs from a user. For example, such devices may include one or more from among a mouse, a touchpad, a keyboard, an eye-gaze system, and a touch interface of a touchscreen. Inputs may be received over a network connection. For example, in the case of server computers, a user may connect to the server over a connection to another computing apparatus and provide inputs to the server using the input devices of the another computing apparatus.

A display unit 999 provides a mechanism to display data visually to a user. The display unit 999 may display user interfaces by which certain locations of the display unit become functional as buttons or other means allowing for interaction with data via an input mechanism such as a mouse. A server may connect to a display unit 999 over a network.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

1. An apparatus comprising processor hardware and memory hardware, the memory hardware storing processing instructions which, when executed by the processor hardware, cause the processor hardware in cooperation with the memory hardware to provide a graphical user interface, (GUI), the GUI being configured to:
display a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells;
respond to an input from a user input mechanism fulfilling a dropdown trigger criteria at an autocompleter cell by opening a dropdown menu corresponding to the said-autocompleter cell;
the dropdown menu comprising a first dropdown menu item and a plurality of second dropdown menu items, wherein the first dropdown menu item is fixed in position at a top position of the dropdown menu throughout display of the dropdown menu;
wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising a filtering input text string.

2. The apparatus according to claim 1, wherein the filtering input string is input received via a keyboard input mechanism or by a paste action and defining a text string, the membership of the dynamic subset being dynamically configurable by filtering out members from a population of candidate cell content objects not including the defined text string.

3. The apparatus according to claim 1, wherein
if the user input mechanism used to change the cell having the focus cell status to the autocompleter cell is a cursor moving device and associated selector, the input fulfils the dropdown trigger criteria and the dropdown menu is automatically opened;
if the user input mechanism used to change the cell having the focus cell status to the autocompleter cell is a tab key of a keyboard, the input does not fulfil the dropdown trigger criteria and the dropdown menu is not opened unless a further input is received fulfilling the dropdown trigger criteria before the cell having the focus cell status is changed.

4. The apparatus according to claim 1, wherein selection of the first dropdown menu item via a user input initiates processing to create a new member of a population of candidate cell content objects, and to set the content of the focus cell according to the new member.

5. The apparatus according to claim 1, wherein
in the dropdown menu, one dropdown menu item at a time has focus item status, the one dropdown menu item having focus item status being dynamic according to focus item navigation inputs received via a user input mechanism, wherein the GUI is configured upon opening the dropdown menu to set the one dropdown menu item having focus item status as one from among the second dropdown menu items.

6. The apparatus according to claim 5, wherein the GUI is configured to respond to a selection input from a user input mechanism while the dropdown menu is open by setting the content of the autocompleter cell having focus cell status according to the dropdown menu item having focus item status.

7. The apparatus according to claim 1, wherein
if a focus cell navigation input to change the cell having the focus cell status away from the autocompleter cell is received by the GUI during display of the dropdown menu at the autocompleter cell, and the user input mechanism used to provide the focus cell navigation input is a keyboard, the GUI responds by setting the content of the autocompleter cell according to the one dropdown menu item currently having focus item status and navigating the focus cell status according to the focus cell navigation input;
if a focus cell navigation input to change the cell having the focus cell status away from the autocompleter cell is received by the GUI during display of the dropdown menu at the autocompleter cell, and the user input mechanism used to provide the focus cell navigation input is a cursor moving device and associated selector, the GUI responds by determining a number of members of a population of candidate cell content text strings match or contain a filtering input text string present in the cell having focus cell status, setting the content of the cell having focus cell status to the filtering input text string, and if the number is one, determining the cell content to be validated, and if the number is zero or greater than or equal to two, determining the cell content to be invalidated and displaying a warning to a user; and navigating the focus cell status according to the focus cell navigation input.

8. The apparatus according to claim 1, wherein
while the cell having focus cell status is the autocompleter cell, a directional down key press from a keyboard fulfils the dropdown trigger criteria and the GUI responds by opening the dropdown menu with a top-most menu item among the second menu items as the dropdown menu item having focus item status;
while the cell having focus cell status is the autocompleter cell, an alphanumeric key press from a keyboard fulfils the dropdown trigger criteria and the GUI responds by opening the dropdown menu with the dynamic subset of members forming the second dropdown menu items is filtered according to the alphanumeric key press applied as a filtering user input, and a top-most menu item among the filtered dynamic subset is set as the dropdown menu item having focus item status.

9. The apparatus according to claim 1, wherein a population of candidate cell content objects is defined on a per column basis according to the column to which each autocompleter cell belongs.

10. The apparatus according to claim 1, wherein the GUI renders the dropdown menu dynamically according to an instantaneous dynamic subset, and wherein a dropdown menu item having focus item status is rendered with a background colour different from a single background colour used to render a background of all other dropdown menu items.

11. The apparatus according to claim 1, wherein,
the autocompleter cell presently having focus cell status has cell content corresponding to a member of the dynamic subset at a time of obtaining focus cell status, and the GUI renders the dropdown menu dynamically according to an instantaneous dynamic subset, and wherein a text string of a dropdown menu item corresponding to the said member of the dynamic subset is rendered with a font colour different from a single font colour used to render text strings of all other dropdown menu items.

12. The apparatus according to claim 1, wherein
each member of a population of candidate cell content text strings is a title or descriptor of an object defined in an application to which the GUI belongs and having at least one property in addition to the title or descriptor, wherein the second dropdown menu items are represented in the menu by the candidate cell content text string being the title or descriptor of the object, and by a tag or label representing, detailing, or indicating one or more of the at least one property additional to the title or descriptor.

13. The apparatus according to claim 1, wherein each member of a population of candidate cell content text strings is a title or descriptor of an object defined in an application to which the GUI belongs comprises, and the dropdown menu further comprises a third dropdown menu item, the third dropdown menu item is an option to leave the cell blank or empty.

14. The apparatus according to claim 1, wherein the graphical user interface is web-based and is a portion of a web-application.

15. The apparatus according to claim 1, wherein the graphical user interface is a single page application.

16. The apparatus according to claim 1, wherein the GUI is operable to dynamically configure membership of the dynamic subset during display of the dropdown menu according to inputs received via user input mechanisms and comprising:
scrolling user inputs; and
a filtering input text string.

17. A computer-implemented method, comprising:
at a graphical user interface (GUI):
displaying a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells;
responding to an input from a user input mechanism fulfilling a dropdown trigger criteria at an autocompleter cell by opening a dropdown menu corresponding to the autocompleter cell;
the dropdown menu comprising a first dropdown menu item and a plurality of second dropdown menu items, wherein the first dropdown menu item is fixed in position at a top position of the dropdown menu throughout display of the dropdown menu;
wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising:
a filtering input text string.

18. A computer program comprising processing instructions which, when executed by a computing apparatus having a memory and a processor, cause the memory and the processor to perform a method comprising:
at a graphical user interface (GUI):
displaying a table of cells arranged to define columns and rows, one cell at a time having focus cell status, the one cell having focus cell status being dynamic according to focus cell navigation inputs received by the GUI from a user input mechanism, the table of cells comprising a plurality of autocompleter cells;
responding to an input from a user input mechanism fulfilling a dropdown trigger criteria at an autocompleter cell by opening a dropdown menu corresponding to the autocompleter cell;
the dropdown menu comprising a first dropdown menu item and a plurality of second dropdown menu items, wherein the first dropdown menu item is fixed in position at a top position of the dropdown menu throughout display of the dropdown menu;
wherein the second dropdown menu items are a dynamic subset of members from among a set of candidate cell content text strings, and wherein the GUI is operable to dynamically configure membership of the dynamic subset during display of the dropdown menu according to inputs received via user input mechanisms and comprising a filtering input text string.
